(19) United States
(12) Patent Application Publication
(10) Pub. No.: US 2021/0211468 A1
(43) Pub. Date: Jul. 8, 2021

(54) SYSTEMS AND METHODS FOR SERVICE COMPLIANCE VIA BLOCKCHAIN

(71) Applicant: Wells Fargo Bank, N.A., San Francisco, CA (US)

(72) Inventors: Phillip H. Griffin, Raleigh, NC (US); Jeffrey J. Stapleton, Arlington, TX (US)

(21) Appl. No.: 15/166,625

(22) Filed: May 27, 2016

(51) Int. Cl. H04L 29/06; H04L 9/00; H04L 9/06; H04L 9/32; H04L 9/14; H04L 9/30; G06Q 20/06; G06Q 20/40

(52) U.S. Cl. CPC H04L 63/20; H04L 63/0428; H04L 63/10; H04L 9/006; H04L 9/0637; H04L 2209/56; H04L 9/14; H04L 9/30; H04L 63/06; G06Q 20/065; G06Q 20/40; H04L 9/3242

(57) ABSTRACT

A method includes defining a service policy. The service policy is stored in a policy blockchain, which includes a plurality of blocks. A first of the blocks includes a first version of the service policy and a second of the blocks includes an update to the first version. A plurality of compliance event logs are captured over a first time period for a plurality of subscribers of the blockchain facilitator. Each of the logs includes a plurality of field-level components. Each of the components are time stamped via a trusted time stamp token. The components are selectively encrypted based on permissions associated with each of the subscribers, and are stored in an event blockchain. The policy blockchain and the components related to a first of the subscribers are accessible by the first subscriber to evaluate compliance of the blockchain facilitator to the service policy regarding the first subscriber.

### BACKGROUND

As data management and online services have evolved, businesses have begun to move their applications and data to various service providers over the internet. For example, the service providers could offer cloud services, tokenization services, certificate authority services, and the like. Each service provider may offer a variety of services different than other service providers in the same industry. For example, in the cloud service provider industry, cloud service providers vary in the service models they offer (e.g., software as a service, platform as a service, infrastructure as a service, etc.) and the deployments of those various services (e.g., private cloud, community cloud, public cloud, hybrid cloud, etc.). Generally, the services and deployment methods allow subscribers to use the service provider's applications and processes. Typically, the subscriber does not manage or control the underlying infrastructure, such as a network, servers, operating systems, storage or even individual application capabilities, with the possible exception of some limited user-specific application configuration settings or possibly limited control.

As businesses enroll in the services of the various internet-centric service provides and cede control of their security management to service providers, they still remain responsible for the protection of their customers' information and the assurance that it is managed in compliance with information security policies.

### SUMMARY

Various embodiments relate to a method performed by a processor of a blockchain facilitator computing system. An example method includes defining a service policy. The service policy is stored in a policy blockchain. The policy blockchain includes a plurality of blocks. A first of the plurality of blocks includes a first version of the service policy and a second of the plurality of blocks includes an update to the first version of the service policy. A plurality of compliance event logs are captured over a first time period for a plurality of subscribers of the blockchain facilitator. Each of the plurality of compliance event logs includes a plurality of field-level components. Each of the plurality of field-level components within each of the plurality of compliance event logs are time stamped via a trusted time stamp token received from a trusted timing authority. The field-level components of the plurality of compliance event logs are selectively encrypted based on permissions associated with each of the plurality of subscribers. The encrypted field-level components are stored in an event blockchain. The policy blockchain and the field-level components of the plurality of compliance event logs related to a first subscriber of the plurality of subscribers are accessible by the first subscriber to evaluate compliance of the blockchain facilitator to the service policy regarding the first subscriber.

Various other embodiments relate to a blockchain facilitator computing system. The blockchain facilitator computing system includes a blockchain system, which includes a policy blockchain and an event blockchain. A server system is in operative communication with the blockchain system. The server system includes a processor and instructions stored in non-transitory machine-readable media. The instructions are configured to cause the server system to define a service policy. The service policy is stored in the policy blockchain. The policy blockchain includes a plurality of blocks. A first of the plurality of blocks includes a first version of the service policy and a second of the plurality of blocks including an update to the first version of the service policy. A plurality of compliance event logs are captured over a first time period for a plurality of subscribers of the blockchain facilitator. Each of the plurality of compliance event logs includes a plurality of field-level components. Each of the plurality of field-level components within each of the plurality of compliance event logs are time stamped via a trusted time stamp token received from a trusted timing authority. The field-level components of the plurality of compliance event logs are selectively encrypted based on permissions associated with each of the plurality of subscribers. The encrypted field-level components are stored in the event blockchain. The policy blockchain and the field-level components of the plurality of compliance event logs related to a first subscriber of the plurality of subscribers are accessible by the first subscriber to evaluate compliance of the blockchain facilitator to the service policy regarding the first subscriber.

These and other features, together with the organization and manner of operation thereof, will become apparent from the following detailed description when taken in conjunction with the accompanying drawings, wherein like elements have like numerals throughout the several drawings described below.

### BRIEF DESCRIPTION OF THE FIGURES

FIG. 1 is a schematic flow diagram illustrating a method of managing a compliance blockchain system, according to an example embodiment.

FIG. 2 is a schematic diagram of a compliance data processing system, according to an example embodiment.

FIG. 3 is a flow diagram illustrating a method of managing blockchain facilitator compliance data via the compliance blockchain system of FIGS. 1 and 2, according to an example embodiment.

FIG. 4A is a schematic flow diagram illustrating a method of managing the policy and event blockchains of FIGS. 1 and 2, according to an example embodiment.

FIG. 4B is a flow diagram illustrating a method of managing the blockchain facilitator policy blockchain of FIGS. 1 and 2, according to an example embodiment.

FIG. 4C is a flow diagram illustrating a method of managing the event blockchain of FIGS. 1 and 2 for multiple clients, according to an example embodiment.

FIG. 5 is a flow diagram illustrating a key exchange method between a blockchain facilitator and a requesting party, according to an example embodiment.

FIG. 6 is a flow diagram illustrating a method of exchanging and managing digital signatures, according to an example embodiment.

FIG. 7 is a flow diagram illustrating a method of associating a trusted time stamp token to compliance data, according to an example embodiment.

FIG. 8 is a compliance blockchain schema, according to an example embodiment.

### DETAILED DESCRIPTION

A blockchain is a publicly viewable, append-only, distributed ledger. A blockchain includes multiple blocks, each containing data and a hash of the previous block, thereby linking the blocks in the blockchain. The current blockchain ecosystem, however, is not suitable to use as a mechanism of storing and managing compliance data. This is in part because the current blockchain ecosystem lacks the capabilities to comply with the legal and regulatory requirements for managing certain types of data, such as time stamping, signatures and encryption. These three features are essential components because the database containing the service provider's compliance data must comply with the data security, regulatory, and legal requirements for service providers. It must be accessible by subscribers and regulators but must also allow only authorized entities to view certain compliance information.

While there are time stamps provided in some blockchain entries that are trusted by user consensus, there are no provisions for trusted time stamps (e.g., those defined in X9.95 and other similar standards by ISO/IEC and other standard-setting organizations) that are mandatory for satisfying current legal and regulatory requirements. Additionally, the current blockchain ecosystem lacks the requisite protocols and standards to comply with the legal and regulatory requirements for digital signatures. For example, the current blockchain protocols only support anonymous blockchain transactions in part by allowing the use of self-signed data elements, which are not acceptable under the current regulatory and legal requirements (e.g., as opposed to systems that support the X9.73 standard, which would be capable of complying with these requirements). Additionally, the public certificates currently supported to generate the public/private key pairs are not associated with a Public Key Infrastructure (“PKI”). These signatures lack the trustworthiness that a PKI can provide. Further, various encryption mechanisms (e.g., those defined in the X9.119 financial services security standard, which outlines regulatory and legal requirements for data security) currently are not part of the existing blockchain protocol. Consequently, there is a need for a blockchain with features that can be used to collect and manage the compliance data needed for security governance in accordance with industry standards and protocols.

Various embodiments described herein relate to systems and methods for managing a service provider's compliance via a compliance blockchain system. The compliance blockchain system is generated and managed by a blockchain facilitator. The blockchain facilitator is the entity that facilitates the use of a compliance blockchain system. In some example embodiments, the blockchain facilitator is the service provider. For example, in some embodiments, the cloud service provider. However, in some embodiments, the blockchain facilitator is a third-party tasked with creating, generating, and facilitating the use of the compliance blockchain system on behalf of the service provider. The compliance blockchain system is structured to provide near real-time security governance to subscribing entities. In one embodiment, a compliance blockchain system includes a policy blockchain and an event blockchain. The policy blockchain includes blockchain facilitator policies. Updates to the blockchain facilitator policies may be recorded in subsequent blocks in the policy blockchain. The policy blockchain may include publicly available data, such as blockchain facilitator policies, as well as selectively encrypted data, such as subscriber practices data. The event blockchain includes blockchain facilitator compliance event data that is captured over time for a plurality of subscribers. The blockchain facilitator may selectively encrypt field-level components of the compliance event data for each one of the subscribers. Each of the field-level components may also be time stamped using trusted time stamps. It should be understood that embodiments described herein are not limited to managing compliance of a service provider. Instead, the embodiments described herein may similarly be performed on other types of systems using other types of data.

As will be appreciated, various embodiments define the processes and schema needed to employ Cryptographic Message Syntax (“CMS”) types that allow for selective restriction of the data and comport with the regulatory and legal requirements for blockchain facilitator data security. The CMS can be ones that comport with those defined in the X9.73 financial services security standard or similar standard that requires protection of compliance data collected from one or more subscribers. The cryptographically protected compliance data is stored in a permissioned blockchain that provides the necessary support for industry required protocols and standards. The X9.73 standard supports symmetric and asymmetric encryption, message authentication code (“MAC”), digital signature, tokenization and signcryption. These key management techniques may be used to protect content of any type or format that is stored in a blockchain ledger managed in a public repository. The CMS types can include the SignedData, SigncryptedData and AuthenticatedData types, as well as attributes bound to these blockchain entry CMS components. The compliance blockchain system also supports and incorporates the X9.119 financial services security standard for the tokenization mechanisms. The mechanisms allow an organization to control the tokens and encrypted content in blockchain entries, to secure the plain text information by tokenization and encryption techniques, and to make it available to auditors, regulators and attorneys by authorizing their access to selective parts of this information and providing them with any needed credentials and keys. Each compliance data entry is time stamped by a recognized trusted time authority in accordance with the X9.95 or similar standard. To provide integrity, authentication, and non-repudiation, the data logs may be signed by the blockchain facilitator, or another entity with authorization to publish to the compliance blockchains, using a digital signature method. It should be understood that “selective encryption” as used herein includes any technique used to selectively restrict access to data.

The compliance blockchain system, in accordance with various embodiments of the present disclosure, enables near real-time security governance by subscribing organizations. The use of the compliance event blockchain, in tandem with the policy and practices blockchain, according to various embodiments, enables blockchain facilitators to provide secure reporting of sensitive compliance data to the blockchain facilitator's subscribers. The policy blockchain is constructed to have unrestricted access to the broad policies of the blockchain facilitator, viewable by potential subscribers, while reserving restricted information relating to the policy-specific practices of the blockchain facilitator for its subscribers. This allows for the blockchain facilitator to protect the confidentiality of the various services and actions the blockchain facilitator will take on behalf of its clients. The compliance blockchain system thus allows for a simple and effective means of selectively encrypting sensitive compliance data, while providing permissioned and selective access to various compliance information to a requesting entity.

The compliance blockchain system provides technical solutions to the computer-centric and internet-centric problems associated with conventional blockchain facilitator (e.g., service provider) compliance systems. For example, the compliance blockchain system, according to various embodiments, provides a more efficient and effective mechanism to the industry by providing a publicly and globally accessible repository for vendor compliance data collection. This data collection is in accordance with industry standards and allows the blockchain facilitator to restrict access to sensitive compliance data to those with a need-to-know. The compliance blockchain system, comprising one blockchain of the blockchain facilitator's policies and practices and another selectively encrypted blockchain of the related blockchain facilitator's compliance event data, allows for a more effective and reliable medium for subscribers, internal auditors, and external assessors monitoring and verifying blockchain facilitator actions. This ledger enables near real-time determination by subscribers of their security posture, the degree to which the blockchain facilitators are in compliance with organization security policies and the status of the organization's security governance activities.

Further, the methods and systems described herein alleviate the strain on processing power and memory components currently required to manage, record, and grant access to compliance data. Additionally, the embodiments herein utilize a less strenuous key management and negotiation method, along with cryptographic message data techniques that provide real-time publishing, protection, and governance of compliance data. For example, in some embodiments, a single instance of the compliance event data is encrypted using a content encryption key and stored in the event blockchain. Access to the compliance event data is selectively provided to entities (e.g., subscribing entities, regulating entities, etc.) on a need-to-know basis by securely sharing the content encryption key using asymmetric encryption techniques. For example, in one embodiment, the content encryption key is encrypted using a key encryption key (“KEK”) that is negotiated with a requesting entity. Access to the underlying compliance event data may be managed using various KEKs (e.g., unique KEKs may be negotiated with different requesting entities, KEKs may be structured to deactivate after a certain amount of time or usage, etc.). Accordingly, the compliance blockchain system permits selective access to the compliance event data without having to re-encrypt the underlying data and store an additional copy of the re-encrypted data, before allowing a requesting entity to access securely the data. Therefore, the compliance blockchain system reduces the processing power and memory storage requirements necessary to provide secure access to compliance data to individual requesting entities. Additionally, the compliance blockchain system reduces the amount of time required to share securely services compliance data with requesting entities, as the underlying data does not have to be re-encrypted before the data may be accessed by the entities.

These problems arise out of the use of computers and the Internet, because services cannot exist without the use of computers and the Internet. Accordingly, problems relating to evaluating service compliance arise out of computers and the Internet. In addition, the inherent structure of blockchain systems, as a distributed digital ledger, cannot exist outside of computers or the Internet. For example, each block contains a hash of the previous block, and it is not possible to compute a hash function without a computer.

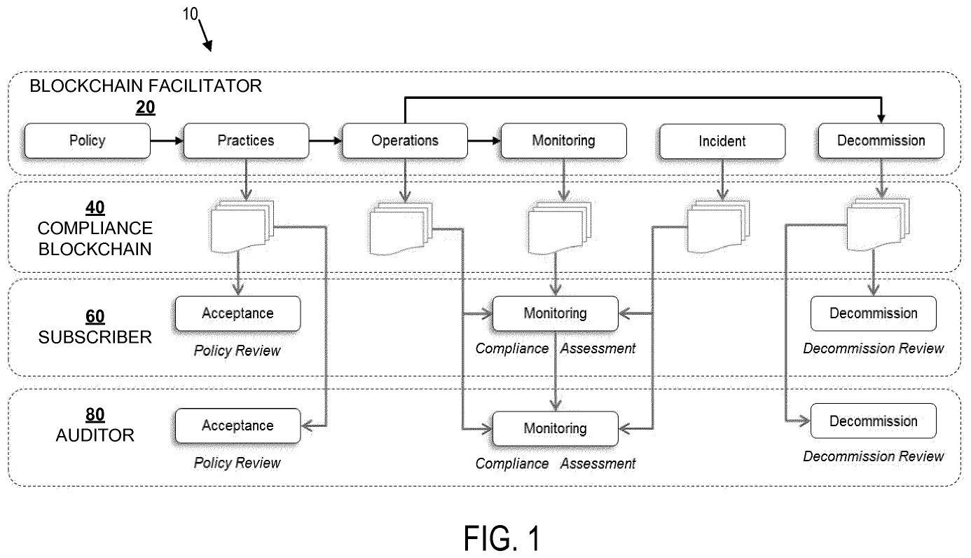

FIG. 1 is a schematic flow diagram illustrating a method 10 of managing a compliance blockchain system, according to an example embodiment. The compliance data processing method 10 includes a blockchain facilitator 20, which generates a compliance blockchain 40, one or more subscribers 60, and an auditor 80. Each of the blockchain facilitator computing system 102, the subscribers 60, the auditor 80, and the compliance blockchain 40 is in operative communication with the others via a network. The compliance data processing method 10 allows for the management of publically viewable blockchain entries for policy data and event data that can have field-level components protected from unauthorized access. Specifically, the encryption techniques allow the compliance information (e.g., the adopted policies, practices, operations, incidents, monitoring, etc.) to be made available to auditors, regulators, subscribers, and legal entities by authorizing access to selective parts of the information in accordance with their credentials and clearance.

The blockchain facilitator 20 generates a plurality of content related to compliance event data. As shown in FIG. 1, the blockchain facilitator 20 generates and adopts a set of policies and practices. Generally, the policy and practice information contains general information related to the obligations and actions the blockchain facilitator 20 would be required to perform throughout the duration of a subscription. The policies and practices are stored on a policy blockchain within the compliance blockchain 40. The blockchain facilitator 20, implementing and complying with the adopted policies and practices, generates event logs that are published to the event blockchain on the blockchain facilitator compliance blockchain. As shown in FIG. 1, the blockchain facilitator 20 provides operations, monitors the operations, generates incident reports in accordance with any findings and decommissions the services, either for a particular subscriber or holistically. The blockchain facilitator's 20 day-to-day operations, internal monitoring and incident reporting are all published to the event blockchain. Each event log is selectively encrypted and accessible for monitoring by entities that possess the proper credentials. The decommissioning of the service to a single subscriber is published to the blockchain and reviewable by the departing subscriber 60 and/or auditor 80. The published policy and event blockchains allow for a subscriber 60 or auditor 80 to accept, monitor, and decommission the services of the blockchain facilitator 20.

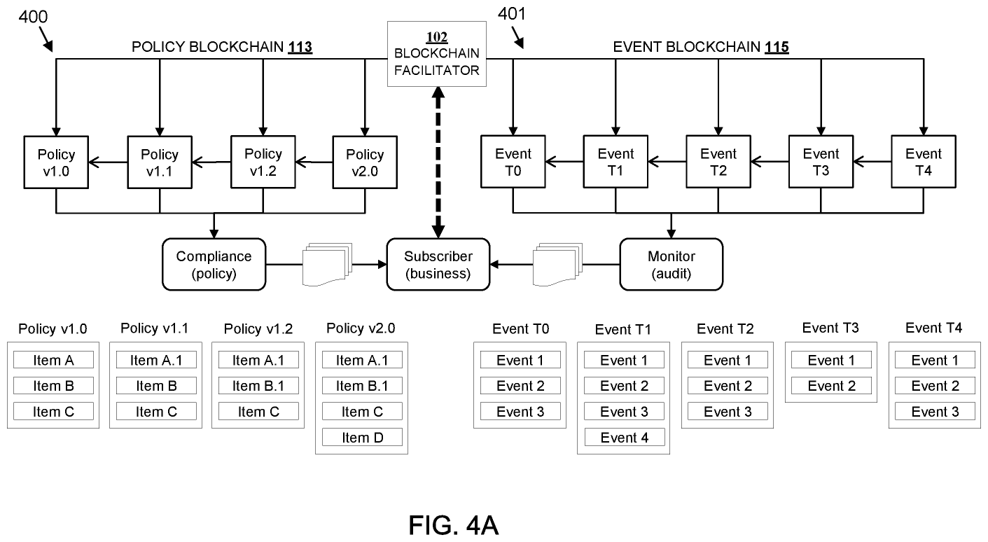

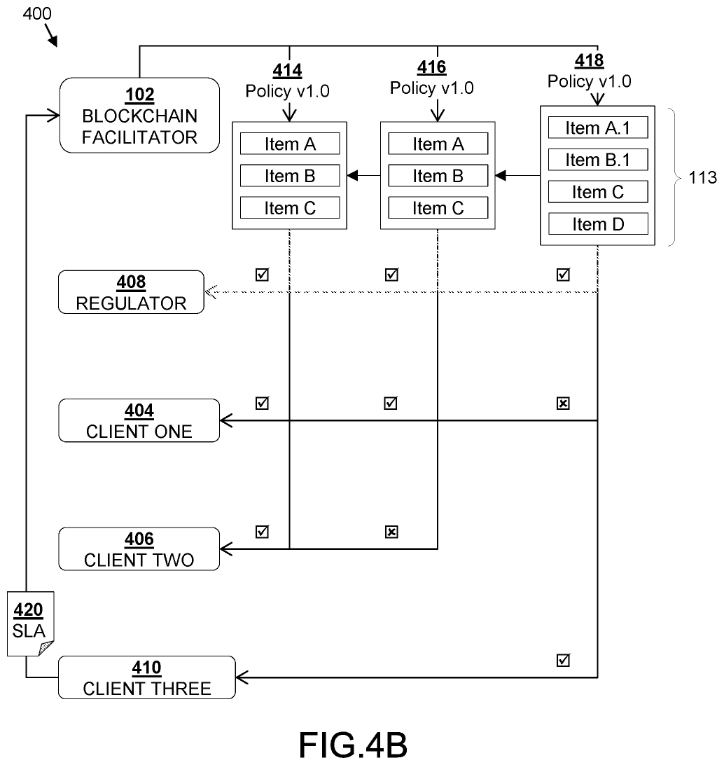

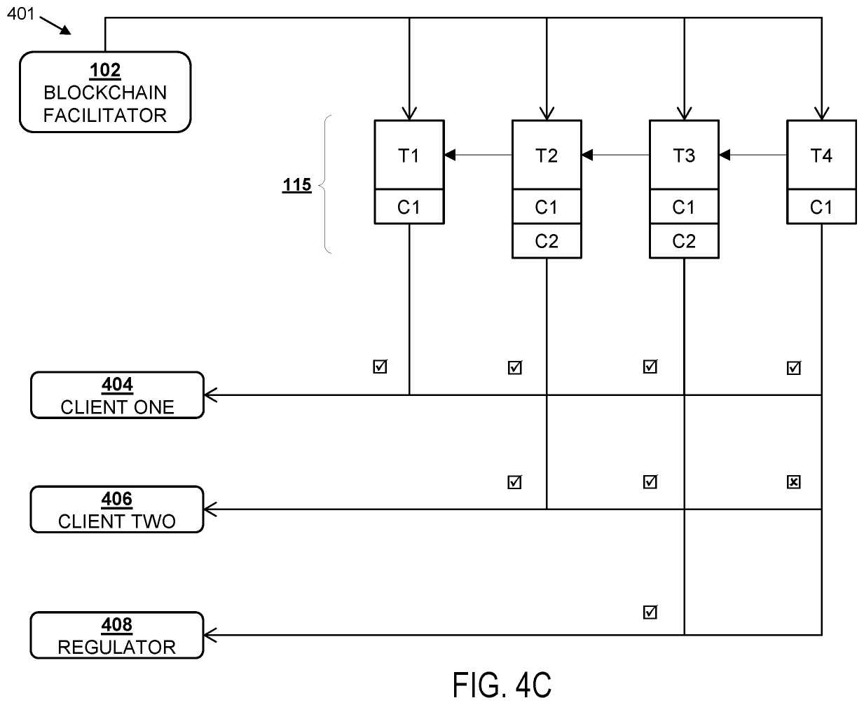

Once the current version of the policies and practices are published to the policy blockchain, entities with the proper clearance may review and accept the policies and practices. The policy information may include non-restricted information, viewable by subscribers, auditors, regulators, potential new subscribers, and the like, without requiring a content encryption key. The practices information can be selectively encrypted and may outline the specific information related to the actions the blockchain facilitator 20 has agreed to take in regards to the blockchain facilitator's 20 policies for one or more subscribers. The subscriber 60 may review the policies and practices related to the subscriber 60 and decide whether to continue the relationship with the blockchain facilitator 20. Additionally, non-subscribers may view the non-restricted information to determine whether to enroll in the blockchain facilitator's 20 services. The auditor 80 may review the policy blockchain to approve that the adopted policies and practices of the blockchain facilitator 20 comply with legal and regulatory rulings. In some arrangements, the auditor 80 receives a content encryption key that allows the agency to review all of the restricted policies and practices. The acceptance process of the policy blockchain is described in greater detail below in FIG. 4B.

As the blockchain facilitator 20 completes operations in accordance with the practices, policies, and procedures, the blockchain facilitator 20 publishes the information to the event blockchain. The operations are selectively encrypted in relation to the subscriber for which the operations were carried out. For example, if the blockchain facilitator 20 were receiving data for Subscriber A, then the event log of the operation would be time stamped, signed, and selectively encrypted using the content encryption key associated with Subscriber A. These published operations on the event blockchain are reviewable by the associated subscriber 60 and the auditor 80. In some arrangements, the auditor 80 receives a content encryption key that allows the agency to review all of the published operations, monitoring, and generation of incident reports on the event blockchain for multiple subscribers. The blockchain facilitator 20 may internally monitor the operations; the blockchain facilitator 20 can monitor on a subscriber-by-subscriber basis or holistically. For example, the blockchain facilitator 20 conducts a daily review of the data traffic for the subscriber base and encrypts the event log as restricted information accessible by the entire subscriber base. Upon monitoring the operations, the blockchain facilitator 20 may generate an incident event log for discovered issues or occurrences outside of the practices and policies. The incident event logs published to the event blockchain may be reviewable either by both the related subscriber 60 and auditor 80, or just the auditor 80. The compliance assessment process of the event blockchain is described in greater detail below in FIG. 4C. In some embodiments, the subscriber 60 or auditor 80 can subsequently signcrypt, tokenize, or encrypt selective fields of content that they have access to through the use of key management techniques or through access controls managed by an external tokenization provider under the subscriber's 60 or auditor's 80 control. For example, the subscriber 60 could access the subscriber-specific information on the event blockchain, extract the information, protect (e.g., signcrypt, tokenize, encrypt, etc.) the information, and publish it on a separate blockchain and/or repository.

At some time period throughout the life cycle of the event blockchain a subscriber 60 may cease services (i.e., decommission) with the blockchain facilitator 20. The subscriber 60 may cease services upon review of the policy blockchain, compliance assessment of the event blockchain, or for other reasons. The subscriber 60 reviews the decommission event log on the event blockchain. In some arrangements, the subscriber 60 is able to access the related restricted event log information after the decommission event. In other arrangements, the information is inaccessible to the subscriber 60 after the decommission event. The auditor 80 may review the decommission event to ensure that the end of the services was in accordance with adopted regulations and that there were no incidents that led to the decommission event.

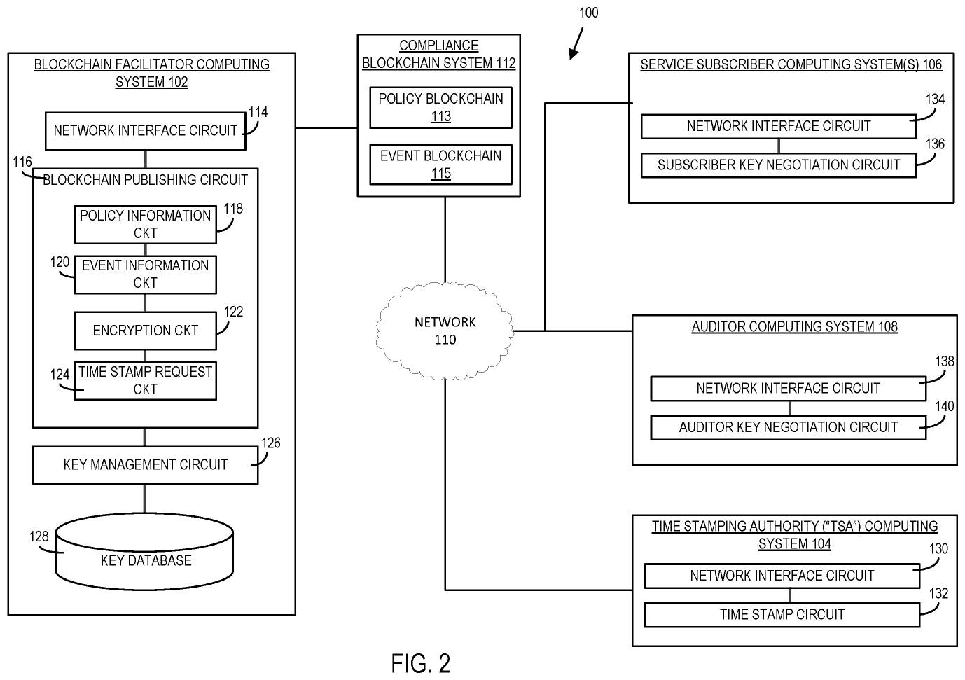

FIG. 2 is a schematic diagram of a compliance data processing system 100, according to an example embodiment. The compliance data processing system 100 includes a blockchain facilitator computing system 102, which generates a compliance blockchain system 112, a time stamping authority (“TSA”) computing system 104, one or more subscriber computing systems 106, and an auditor computing system 108. Each of the blockchain facilitator computing system 102, the TSA computing system 104, the subscriber computing system 106, the auditor computing system 108, and the compliance blockchain system 112 are in operative communication with the others via a network 110. These mechanisms allow management of publicly viewable blockchain entries that contain field-level components protected from unauthorized access. Specifically, the encryption techniques make it possible for the compliance information to be made available to auditors, regulators, subscribers, and attorneys by authorizing their access to selective information and providing them with any needed credentials and keys. According to various embodiments, the system 100 may be utilized to implement the method of FIG. 1. The blockchain facilitator computing system 102 may be managed by the blockchain facilitator 20 of FIG. 1, the subscriber computing system 106 may be managed by the subscriber 60 of FIG. 1, and the auditor computing system 108 may be managed by the auditor 80 of FIG. 1. Additionally, the blockchain facilitator Compliance blockchain 40 of FIG. 1 may be a part of the compliance blockchain system 112.

The network 110 may include, for example, the Internet, cellular networks, proprietary cloud networks, and the like. The compliance blockchain system 112 comprises a policy blockchain 113 and an event blockchain 115. The compliance blockchain system 112 is structured to store a plurality of blockchain facilitator policies, practices and compliance event data on the policy and event blockchains 113, 115. In particular, a policy blockchain 113 may include both non-restricted policy information and restricted practice information. The event blockchain 115 includes a plurality of selectively restricted compliance event data for a plurality of subscribers to the blockchain facilitator's services. Some embodiments include a plurality of event blockchains 115. For example, in some embodiments, a separate (e.g., parallel) event blockchain 115 is created for events related to each subscriber. In some embodiments, a separate event blockchain 115 is created for events related to a specific version of a policy. In some embodiments, a separate event blockchain 115 is created for events related to specific parameters of a particular version of a policy. In some embodiments, a separate event blockchain is created for events having particular selective encryption. For example, in some embodiments, a separate event blockchain is created for events in which selective encryption is managed by a subscriber, auditor, or other third-party. In other embodiments, the blockchain facilitator manages the blockchain system 112 for a third-party service provider. In such embodiments, the policies and practices in the policy blockchain 113, and the event data in the event blockchain 115, relate to the service provider rather than the blockchain facilitator.

Generally, the blockchain facilitator may use the compliance data processing system 100 to publish a set of blockchain facilitator policies and practices and compliance data events, over a period of time, to respective blockchains. Additionally, the blockchain facilitator can selectively encrypt the policies, practices and/or compliance data events using one or more content encryption keys to provide permissioned layers to the blockchain. The blockchain facilitator also uses the compliance data processing system 100 for key management, negotiating key transport, and establishing key agreements for one or more of the content encryption keys to a requesting entity. Once a requesting entity has received the content encryption keys for the blockchain information they have permission to view, the requesting entity can view the information to monitor blockchain facilitator compliance, actions, etc., over the duration of the blockchain's existence. The compliance data processing system 100 provides the blockchain facilitator with a system for cataloging compliance data with security, assurance, and integrity more efficiently and effectively than currently available. Subscribers, regulators, auditors, and the like can request access and, if granted, compare the compliance event data on the event blockchain 115 to the practices and policies of the blockchain facilitator to monitor and confirm compliance.

For example, the blockchain facilitator may have two subscribing entities, Client A and Client B, to whom it is providing services. The blockchain facilitator may monitor events for Client A and publish the compliance event log onto the blockchain using a trusted timestamp entity and an encryption algorithm. The blockchain facilitator may monitor events for Client B and publish Client B's event log onto the same event blockchain 115 using a trusted timestamp entity and either the same or a different encryption algorithm than the one used for Client A. The blockchain facilitator may grant access to Client A or Client B's information on the blockchain by negotiating a key exchange with an approved entity requesting access. The key may be a one-time use key or may be a multi-use key. The key may grant access to specific information regarding a single client, a single event, all of the information on the blockchain or some combination thereof. It should be understood that any of the cryptographic techniques (e.g., the trusted timestamps, signed data, authenticated data, encryption, etc.) described herein can be utilized in each of the individual data elements within the blockchain, in groups of data elements within the blockchain, or across the entire blockchain.

The blockchain facilitator computing system 102 includes a network interface 114, a blockchain publishing circuit 116, a key management circuit 126, and a key database 128. The network interface 114 is structured to facilitate operative communication between the blockchain facilitator computing system 102 and other systems and devices over the network 110. The blockchain facilitator computing system 102 may, for example, include one or more servers each with one or more processors configured to execute instructions stored in a memory, send and receive data stored in the memory, and perform other operations to implement the compliance services described herein associated with the processing modules, databases and processes shown.

The blockchain publishing circuit 116 is structured to receive blockchain facilitator related information (e.g., policies, practices, compliance data events, etc.), determine whether the information should be published to the policy or event blockchains 113, 115, determine what, if any, encryption should be used to process and protect the data, and ultimately publish the data to the correct blockchain in the correct format on the compliance blockchain system 112. The blockchain publishing circuit 116 receives information from the blockchain facilitator computing system 102 as compliance events occur or as policies and practices change. The blockchain publishing circuit 116 includes a policy information circuit 118, a compliance event information circuit 120, an encryption circuit 122, and a time stamp request circuit 124.

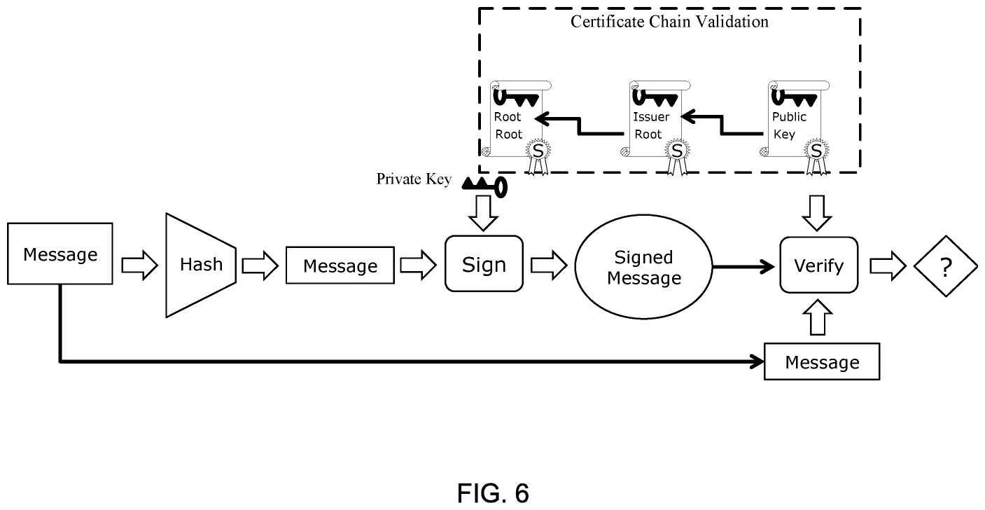

In some arrangements, the blockchain publishing circuit 116 utilizes a digital signature method to provide authentication, integrity, and non-repudiation to a future verifier. The method could be used by one or more of the circuits that comprise the blockchain publishing circuit 116, for example the policy information circuit 118 or the event information circuit 120. In those arrangements, the circuits within the blockchain publishing circuit 116 generate a MAC using a specific symmetric cipher mode of operation called cipher block chaining. Alternatively, the circuits within the blockchain publishing circuit 116 could generate a keyed hash message authentication code (“HMAC”) that uses a hash algorithm instead of the symmetric cipher. A process flow example of using the HMAC signature method is described below in connection with FIG. 6.

The policy information circuit 118 is structured to organize and publish information related to the policies and practices of the blockchain facilitator for the subscribers of the blockchain facilitator's services to the policy blockchain 113. For example, a policy of the blockchain facilitator may be to monitor the access traffic of all subscribers, whereas the practices regarding the policy may be that the blockchain facilitator will monitor the access points and traffic flow only during peak internet usage hours. The policy information circuit 118 also organizes the information into restricted and non-restricted information. The restricted information is encrypted by a content encryption key via a corresponding encryption algorithm, whereas the non-restricted information is unencrypted and can be viewed by any entity that accesses the policy blockchain 113 in the compliance blockchain system 112. For example, the blockchain facilitator policies may include non-restricted information, viewable by subscribers, auditors, regulators, potential new subscribers, and the like, without requiring a content encryption key.

The policy information can contain general information related to the obligations and actions the blockchain facilitator would be required to perform throughout the duration of a subscription. The practices information can be selectively encrypted and may outline the specific information related to the actions the blockchain facilitator has agreed to take in regards to the blockchain facilitator's policies for one or more subscribers. The practice information may be specific to one subscriber. For example, the policy blockchain 113 may contain non-restricted policy information of the blockchain facilitator that the blockchain facilitator will inform subscribers of all data breaches in a timely manner, whereas the restricted practice information on the policy blockchain 113 can be that the blockchain facilitator will notify Subscriber A within 15 hours, Subscriber B within 20 hours and all other subscribers within 24 hours. The different practices could be a result of a service level agreement (“SLA”) between Subscribers A and B and the blockchain facilitator. The practice data needs to be restricted for security purposes: third party entities (and potential security attackers) should not know the exact time it will take the blockchain facilitator to notify of data breaches, and the other subscribers do not need to know of the specific negotiated terms of other subscribers on the system, for confidentiality purposes.

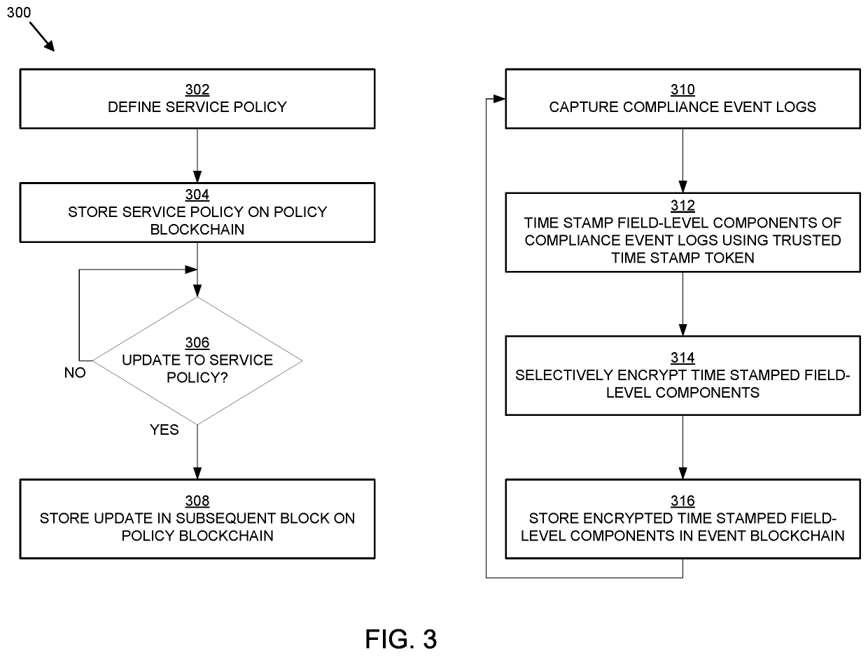

The policy information circuit 118 is in communication with the time stamp request circuit 124 to time stamp the policy and practice information, and with the encryption circuit 122 to encrypt the information determined to be restricted. The policy information circuit 118 is structured to organize the adopted blockchain facilitator policies and publish the group of unencrypted policies to the policy blockchain 113. The policy information circuit 118 facilitates encryption for the specific practices related to the unencrypted policies published on the policy blockchain 113. Certain practices may be subscriber-specific (e.g., agreed upon in an SLA between the blockchain facilitator and subscriber). For example, in the subscriber-specific practice, the policy information circuit 118 may transfer a Subscriber A-specific practice to the encryption circuit 122 with instructions to encrypt it according to the encryption algorithm used for Subscriber A. Other practices may be universal for all subscribers. In some arrangements, the policy information circuit 118 can organize and time stamp events as they occur and then encrypt and publish the plurality of events to the appropriate blockchain. For example, the policy information circuit 118 may store and time stamp all the adopted practice events for a plurality of subscribers over a given time period, (e.g., a week) and, at the end of the period, the policy information circuit 118 can determine the level, if any, of restriction for the practices and publish the encrypted time stamped information to the policy blockchain 113. In other arrangements, the policy information circuit 118 can publish the practices to the appropriate blockchain as they are agreed upon, changed or extinguished. An example flow diagram illustrating the policy blockchain 113 is described below in connection with FIG. 3 and FIG. 4B. In some embodiments, the policy blockchain 113 includes multiple different service policies and practices (e.g., corresponding to different products, different subscribers, etc.). In some embodiments, the different service policies and practices are stored in individual policy blockchains 113. However, in other embodiments, the different services policies and practices are stored in a single policy blockchain 113.

The compliance event information circuit 120 is structured to organize and publish the information related to the compliance events of the blockchain facilitator in the course of providing services to the blockchain facilitator's subscribers. For example, compliance event information may define that at time A the blockchain facilitator detected a Denial of Service (“DoS”) attack on the services provided to Subscriber A and that at time B the DoS attack was mitigated. The compliance event information circuit 120 organizes the compliance information as it is generated, facilitating the time stamping of the data and determining the commands for the encryption circuit 122 to selectively restrict the information. For example, the compliance event information circuit 120 would receive the DoS event information upon detection, send the information to the time stamp request circuit 124 to receive a time stamp token and determine that the DoS attack occurred on Subscribers A and B's services, requiring the DoS data information to be encrypted in accordance with the encryption algorithms used for Subscriber A and Subscriber B, respectively.

The compliance event information circuit 120 may implement a variety of publishing mechanisms depending on the desired schema of the blockchain facilitator. In some arrangements, the event information circuit 120 can catalog and time stamp events as they occur and then encrypt and publish the plurality of events to the appropriate blockchain, corresponding to the compliance actions for a plurality of subscribers. For example, the event information circuit 120 may store and time stamp all of the compliance events for a plurality of subscribers in a given day, facilitate the encryption of the information by the corresponding subscriber-specific content encryption keys and, after 24 hours, publish the time stamped, encrypted information to the event blockchain 115. In other arrangements, the event information circuit 120 can publish the data to the event blockchain 115, time stamped, and encrypted, as each data event occurs/is generated by the blockchain facilitator computing system 102.

In some arrangements, the compliance event information circuit 120 may catalog the compliance event data within the information string eventually encrypted and published to the blockchain. The cataloging involves the compliance event information circuit 120 determining the corresponding policy and/or practice on the blockchain facilitator policy information blockchain for the compliance event that has occurred. The cataloging may include a pointer or identifier within the compliance event data entry that points to the corresponding policies and practices on the policy blockchain 113 for the compliance event type and, if applicable, the subscriber-specific practice (e.g., one previously agreed to in an SLA). The cataloging would ease the burden on future regulating entities and auditors by providing a reference to the corresponding practice and policy for each compliance event data entry, limiting the time required for cross-referencing. The identifier may be an information object identifier (“OID”). In some embodiments, the OID is generated based on ISO/IEC 8824 and ISO/IEC 9834 standards. In further embodiments, the OID is a universally unique identifier (“UUID”) or a globally unique identifier (“GUID”) variation thereof (e.g., as defined in the ISO/IEC 9834-8 standard). In still further embodiments, the OID is a uniform resource identifier (“URI”) (e.g., as defined in RFC 2396). Additionally, in some embodiments, the OID is a cryptographic hash, digital signature, MAC HMAC, or tokenized representation of the service practices and policies, which may be used in an instance of communication or information exchange to uniquely identify a specific version of the service practices and policies.

The compliance event information circuit 120 is in communication with the time stamp request circuit 124 to time stamp the compliance event information, and with the encryption circuit 122 to encrypt the information determined to be restricted. The compliance event information circuit 120 facilitates encryption for the specific compliance event data related to a specific subscriber. The compliance event information circuit 120 determines the subscriber information for the compliance event data and sends the information to the encryption circuit 122 for encryption of the compliance event data in accordance with the encryption algorithm used to encrypt selectively that subscriber-specific information. Upon receipt of the time stamped, encrypted compliance information, the compliance event information circuit 120 publishes it to the event blockchain 115. In some embodiments, the compliance event information circuit is structured to create an associated event blockchain 115 for each cloud services practices and policies in the policy blockchain 113. An example flow diagram illustrating the event blockchain 115 is described below in connection with FIG. 4C.

The encryption circuit 122 is structured to receive a set of cleartext (original, non-encrypted information) from the policy or event information circuits, 118, 120, and process the information using an encryption algorithm to generate restricted and undecipherable ciphertext. To accomplish the encryption, the encryption circuit 122 uses a content encryption key that corresponds to the encryption algorithm instructions, along with the field-level information (e.g., a blockchain facilitator practice, a compliance event, etc.) received either from the policy information circuit 118 or the compliance event information circuit 120. For example, the event information circuit 120 may provide the encryption circuit 122 with a set of compliance event information with the instructions to encrypt it in accordance with the algorithm used for processing blockchain facilitator Subscriber A's information. To properly encrypt the information, the encryption circuit 122 is in communication with the key management circuit 126 to retrieve an already existing content encryption key or to request the key management circuit 126 generate a new content encryption key. In some arrangements, the encryption circuit 122 requests that the key management circuit 126 generate the same key for encryption of the blockchain information and subsequent decryption of the blockchain (e.g., if the blockchain utilizes a symmetric encryption algorithm). In other arrangements, the encryption circuit 122 requests that the key management circuit 126 generate one key for encryption and a different key for decryption. For example, the blockchain may utilize key management techniques in support of asymmetric encryption, such as NamedKeyEncryptedData, SigncryptedData, EnvelopedData, or similar cryptographic message types. In some arrangements, the encryption algorithm complies with the standards outlined in X9.73 standard for data security, or other similarly adopted industry security standards. In other arrangements, the encryption circuit 122 uses a tokenization method that complies with X9.119 standard or other similarly adopted industry security standards. Tokenization is a form of obfuscating the cleartext such that it is replaced with a pseudonym data element in the form of a token. The tokens may be generated, stored, and maintained by an entity that specializes in the tokenization process (e.g., a token service provider). The token service provider would handle receiving requests to detokenize (e.g., return the cleartext for a token) for an authorized party. The tokenization and encryption techniques may be made available to auditors, regulators, and attorneys by authorizing their access to selective parts of this information and providing them with any needed credentials and keys. As mentioned, some embodiments utilize signcryption. For example, in some embodiments, the encryption circuit 122 signcrypts a block or field-level components within a block using a public key component of a public/private key pair of a permissioned entity (e.g., a subscriber) and a public/private key pair of the permission grantor (e.g., the blockchain facilitator). For example, the blockchain facilitator uses three keys to singcrypt, and the three keys include a private key and a public key of an asymmetric key pair of the blockchain facilitator and a second public key of a second asymmetric key pair of the first subscriber.

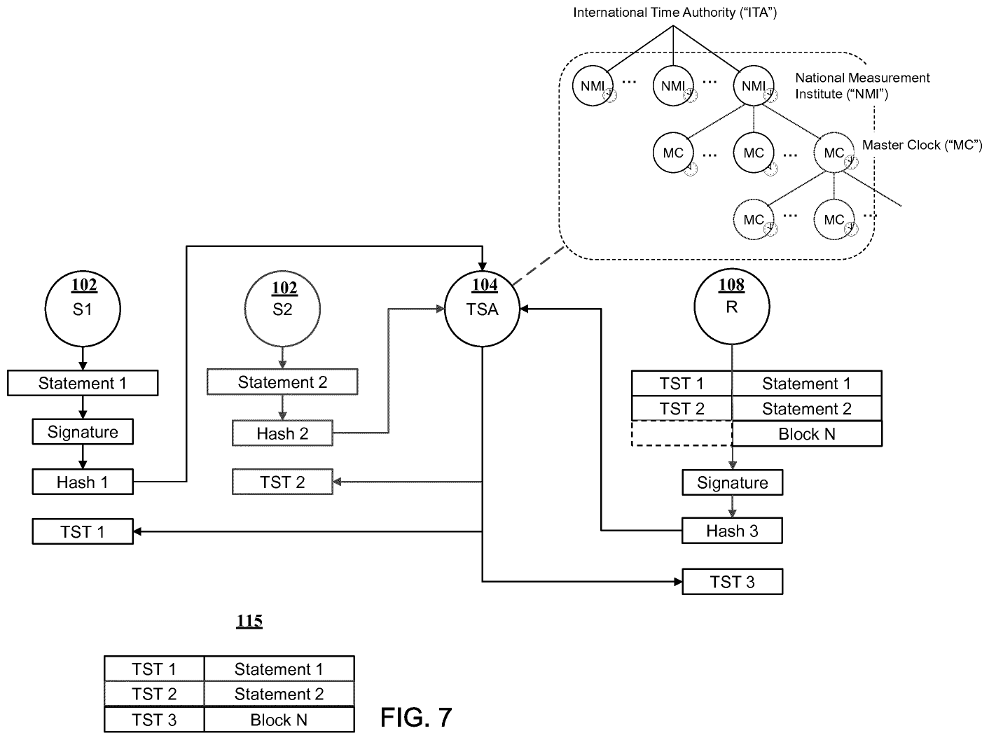

The time stamp request circuit 124 is structured to communicate with the TSA computing system 104 to negotiate a trusted (e.g., recognized by regulators, auditors, members of the financial sector, etc. as a trustworthy time stamp) time stamp token for a piece of information. The time stamp request circuit 124 is in communication with the policy information circuit 118 and the event information circuit 120 to negotiate a trusted time stamp for the blockchain facilitator related information as the information is generated. Trusted time stamping provides authentication, integrity, and non-repudiation to the various data entries. In some arrangements, an information data entry is digitally signed by the generating entity (e.g., the blockchain facilitator) before it is sent to the TSA computing system 104. In some embodiments, the time stamp request circuit 124 generates a hash of the information data entry using a hashing algorithm. The time stamp request circuit 124 submits the hash of the information data entry with a request to the TSA computing system 104 to generate a time stamp token. After submission of the request, the time stamp request circuit 124 receives a trusted time stamp token from the TSA computing system 104. The time stamp token may include the hash of the information data entry and the time the hash of the information data entry was received by the TSA computing system 104. The time stamp request circuit 124 links the information data entry and the trusted time stamp token. The trusted time stamp token allows for a verifying entity to compare the hash of the information data entry to the information data entry to verify that they correspond to the same information and, because the TSA is trusted, that the information data entry was generated at the time indicated on the time stamp. An example flow diagram of this process is shown in FIG. 7.

In some arrangements, the time stamp request circuit 124 may time stamp each individual information data entry as it is generated by the blockchain facilitator's actions. For example, as the blockchain facilitator practices are adopted between the blockchain facilitator and a subscriber, the new practice details entry will be time stamped upon completion of the arrangement and published to the policy blockchain 113. In some embodiments, the time stamp request circuit 124 may collect a plurality of information data entries before getting the plurality time stamped. For example, the blockchain facilitator may adopt a plurality of different policies, all generated at different times, but only time stamp the entire collection (e.g., version one, version two, etc.) of policies. In some arrangements, the time stamp request circuit 124 may be required to do both. For example, with the event blockchain 115, each individual compliance event entry is time stamped and can be stored until the end of a day and the subsequent collection of information, containing all of the various compliance events over the 24 hours, can be time stamped and published to the event blockchain 115. This arrangement provides two levels of compliance information: first, that the blockchain facilitator is complying with the compliance policies that comprise the individual compliance events over the 24 hours and, second, that the blockchain facilitator is publishing the event blockchain 115 every day.

The key management circuit 126 is structured to receive an access request, authenticate the requestor, and provide the content encryption key that corresponds to the information access level of the requestor. The key management circuit 126 facilitates the process for securely managing the content encryption keys (e.g., cryptographic keys) over their lifecycle, including key generation, distribution, usage, backup, revocation, termination, archiving and similarly related processes.

The key management circuit 126 generates a content encryption key for an encryption technique (e.g., algorithm, processing method, tokenization, etc.) used by the encryption circuit 122, either for a specific purpose or for a specific duration, depending on the number of subscribers and access requirements. For example, the key management circuit 126 may generate a single content encryption key for all information related to a single subscriber, allowing the key management circuit 126 to exchange securely the content encryption key with the subscriber viewing all of the information on the policy and event blockchain 115 that relates to the subscriber. Alternatively, the key management circuit 126 may generate a master content encryption key that allows the holder of the key to access all the restricted information on the policy and event blockchains 113, 115 in its entirety or for a specific block entry within the blockchain. For example, the blockchain facilitator may have a regulating entity that needs to be able to access the compliance event information and the corresponding policies and procedures, thus the master key would allow the regulating entity to access all the information relevant to compliance with regulations. The generation of the content encryption key is related to the encryption algorithm used by the encryption circuit 122. In some arrangements (e.g., for symmetric encryption algorithms), the key management circuit 126 generates the same key for encryption of the blockchain information and subsequent decryption of the blockchain. In other arrangements (e.g., for asymmetric encryption algorithms), the key management circuit 126 generates one key for encryption and a different key for decryption.

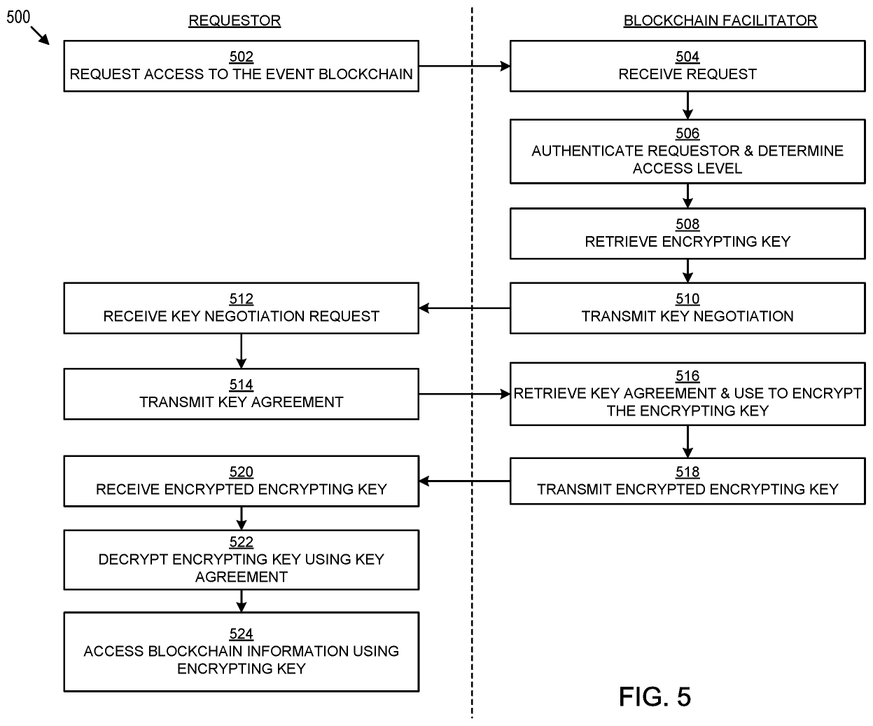

The key management circuit 126 distributes keys upon receipt of a request to view restricted information on one of the blockchains or in accordance with a prior agreement, for example, when a subscriber requests to view the event blockchain 115 information related to the subscriber. The key management circuit 126 may utilize a variety of mechanisms for key establishment (e.g., to exchange the content encryption key with the entities that require access). An example flow diagram of a key establishment method is shown in FIG. 5. The key management circuit 126 may use key transport or a key agreement. In some arrangements, the key management circuit 126 utilizes a symmetric key exchange, in which the same KEK is used to encrypt and decrypt the content encryption key. In other arrangements, the key management circuit 126 utilizes an asymmetric key exchange, in which one KEK is used by the encryption circuit 122 to encrypt the content encryption key and a different but associated KEK is used by an entity to decrypt the content encryption key. An example of the asymmetric key exchange is generating and using an encrypting public KEK and an associated decrypting private KEK.

In arrangements where the key management circuit 126 uses a key transport key establishment method, a symmetric KEK is generated by the blockchain facilitator and transmitted as ciphertext (e.g., cleartext that has been encrypted) to the other party. This key transport requires that the blockchain facilitator and the requesting entity have previously established a KEK that will encrypt the content encryption key exchanges between the two entities. There are several methods that may be used to establish the KEK, including asymmetric key transport, key agreement protocol, or manual methods including key components or key shares. The key management circuit 126 is structured to document the various procedures and practices for the various entities and keys generated. Examples of key transport schemes include the RSA optimal asymmetric wrapping scheme and the RSA key encapsulation mechanism and key wrapping scheme. In one arrangement, the blockchain facilitator retrieves or generates the content encryption key from the content encryption key database 128 and encrypts the content encryption key using the asymmetric public KEK of the receiver (e.g., subscriber, auditor, regulator, etc.) and transmits the ciphertext to the receiver. The receiver decrypts the ciphertext using the receiver's asymmetric private KEK to recover the content encryption key. In this key transport arrangement, the receiver's public KEK would have been provided previously to the blockchain facilitator and used exclusively for key transport.

In some arrangements, where the key management circuit 126 uses a key agreement key establishment method, both sides negotiate the symmetric KEK without having to transmit it as ciphertext. In these arrangements, the blockchain facilitator and the requesting entity each have their own respective asymmetric private KEK and public KEK certificates. The key management circuit 126 negotiates the exchange of the blockchain facilitator certificate and the requesting entity certificate. The key management circuit 126 would generate the blockchain facilitator's asymmetric key pair and use the requesting entities public key to compute a common shared secret that can be used to generate a KEK. For example, the key agreement method could use the Diffie-Hellman method.

In addition to managing key confidentiality during content encryption key exchanges, the key management circuit 126 is also structured to maintain key integrity and authentication. The key management circuit 126 can detect any adversarial or inadvertent modification or substitution of the keys. The key management circuit 126 stores the disturbed and generated keys for future use or referencing. Additionally, the key management circuit 126 ensures that the use of the symmetric and asymmetric private keys is restricted to authorized entities.

The key management circuit 126 manages the content encryption key database 128, which is a database that includes all of the content encryption keys and KEKs generated throughout the duration of the blockchain. The content encryption keys include those used by the blockchain policy information circuit 118 to encrypt the information on the blockchains. The KEKs include those generated by the key management circuit 126 and distributed between the blockchain facilitator and the requesting entities. The key database may contain KEKs and content encryption keys that correspond to a subscriber, a blockchain block, a single log entry within a blockchain block, a master key for all of the blockchain or any combination thereof.

The TSA computing system 104 includes a network interface 130 and a time stamp circuit 132. The TSA computing system 104 is managed by any trusted time authority that can provide a trusted time token for a piece of information or data entry. The trusted time authority can be one that complies with the X9.95 standard, or those defined in similar standards by ISO/IEC, and satisfies the legal and regulatory requirements. In some embodiments, the TSA computing system 104 may be contained in, and controlled by, the blockchain facilitator computing system 102. The TSA computing system 104 may, for example, include one or more servers each with one or more processors configured to execute instructions stored in a memory, send and receive data stored in the memory, and perform other operations to implement the compliance services described herein associated with the processing modules, databases and processes shown. This process is described below in greater detail in FIG. 7.

The network interface 130 is structured to facilitate operative communication between the TSA computing system 104 and the blockchain facilitator computing system 102 over the network 110. The time stamp circuit 132 is structured to negotiate a trusted time stamp token, which includes, receiving a hash of a piece of information and generating a trusted time stamp token for the information for future verification.

The subscriber computing system 106 includes a network interface 134 and a subscriber key negotiation circuit 136. The subscriber computing system 106 is managed by an entity that subscribes to the services provided by the blockchain facilitator that runs the blockchain facilitator computing system 102. The subscriber computing system 106 may, for example, include one or more servers each with one or more processors configured to execute instructions stored in a memory, send and receive data stored in the memory, and perform other operations to implement the compliance services described herein associated with the processing modules, databases, and processes shown. In some arrangements, the service subscribers may have permission to submit filed-level components to the blockchain facilitator to be selectively encrypted and published to the event blockchain 115.

The network interface 134 is structured to facilitate operative communication between the subscriber computing system 106 and the blockchain facilitator computing system 102 over the network 110. The subscriber key negotiation circuit 136 requests access to view restricted information on a blockchain facilitator blockchain and negotiates, with the key management circuit 126 of the blockchain facilitator computing system 102, a KEK to securely transport the content encryption key that corresponds to the information access level of the subscriber. In some arrangements, the subscriber computing system 106 receives a content encryption key that decrypts all encrypted compliance and practice information related to the specific subscriber throughout the subscriber's enrollments in the blockchain facilitator's service.

The auditor computing system 108 includes a network interface 138 and an auditor key negotiation circuit 140. The auditor computing system 108 is managed by an entity that is tasked with reviewing or monitoring the compliance of the services provided by the blockchain facilitator that runs the blockchain facilitator computing system 102. The auditor computing system 108 may be run by an auditing agency of one of the subscribers of the subscriber computing system 106, a regulatory entity of blockchain facilitator providers or the services of the blockchain facilitator or any other similar entity that is not a subscriber but requires access to the information stored on the policy and event blockchains 113, 115 on the compliance blockchain system 112. The auditor computing system 108 may, for example, include one or more servers each with one or more processors configured to execute instructions stored in a memory, send and receive data stored in the memory, and perform other operations to implement the compliance services described herein associated with the processing modules, databases, and processes shown. In some arrangements, the auditor may be a permissioned stakeholder. For example, the compliance blockchain system 112 may be a permissioned blockchain, and the auditor may have permission to submit filed-level components to the blockchain facilitator to be selectively encrypted and published to the policy or event blockchains 113, 115.

The network interface 138 is structured to facilitate operative communication between the auditor computing system 108 and the blockchain facilitator computing system 102 over the network 110. The auditor key negotiation circuit 140 requests access to view restricted information on a blockchain facilitator blockchain and negotiates with the key management circuit 126 of the blockchain facilitator computing system 102 a KEK to securely transport the content encryption key that corresponds to the information access level of the auditor. In some arrangements, the auditor computing system 108 receives a content encryption key that decrypts all encrypted compliance and practice information related to the access level of the auditor. For example, if the auditor computing system 108 is managed by a blockchain facilitator regulation entity, the regulator may be provided with a master content encryption key that allows them to view all of the encrypted information on the blockchains to determine compliance of services by the blockchain facilitator.

Referring to FIG. 3, a flow diagram of a method 300 of managing blockchain facilitator compliance via the compliance blockchain system of FIGS. 1 and 2 is shown, according to an example embodiment. In one example embodiment, the method 300 is performed by the blockchain facilitator computing system 102 of FIGS. 1 and 2, via operative communication with the subscriber computing system 106, the TSA computing system 104, and the compliance blockchain system 112 over the network 110. However, it should be understood that the method 300 may similarly be performed using other systems and devices.

As will be appreciated, blocks 302-308 relate to one or more blockchain facilitator policies stored on the policy blockchain 113 (FIG. 1). Blocks 310-316 relate to blockchain facilitator compliance event logs stored on the event blockchain 115 (FIG. 1). It should be understood that these two flows may operate in parallel. However, in one embodiment, at least a first version of the service policy is published to the policy blockchain 113 prior to blocks 310-316 being executed, and thus the blockchain facilitator compliance event logs being stored on the event blockchain 115.

At 302, a service policy is defined. In effect, this is a “first version” of a service policy. The service policy includes procedures, expectations and other agreements between the blockchain facilitator and the subscribers of the blockchain facilitator. Simply put, it is what the blockchain facilitator is obligated to do in connection with providing the service to subscribers. The policies may also include specific practices that the blockchain facilitator will carry out, which may be defined with respect to a specific subscriber or may be applicable to multiple subscribers. The practices can be encrypted so as to be selectively accessible by one or more subscribers. In some embodiments, the policies and practices are also time stamped (e.g., by receiving a trusted time stamp token from the TSA computing system 104 of FIG. 2).

At 304, the service policy is stored on (e.g., “published to”) the policy blockchain 113. One or more trusted time stamp tokens received at 302 may also be stored on the policy blockchain 113.

At 306, it is determined whether the blockchain facilitator policy is updated. The blockchain facilitator policy may be updated with respect to policy terms that apply to all subscribers or with respect to policy or practice terms that apply to one or more particular sub scribers.

At 308, upon the blockchain facilitator policy being updated at 306, the update to the blockchain facilitator policy is published to a subsequent block on the policy blockchain 113. In some embodiments, only the incremental updates are published to subsequent blocks on the policy blockchain 113. However, in other embodiments, the complete updated blockchain facilitator policy is published to the subsequent blocks on the policy blockchain 113. As the blockchain facilitator policy is updated over time, additional blocks are added to the policy blockchain 113.

At 310, blockchain facilitator compliance event logs are captured over a first time period. For example, the blockchain facilitator compliance event logs may include subscriber-related compliance actions performed by the blockchain facilitator related to the blockchain facilitator's required policies and practices. The compliance events may include, for example, the execution of procedures, blockchain facilitator actions and other interactions of the blockchain facilitator arising from the duties, and practices performed for the subscribers. Each of the blockchain facilitator compliance event logs may include a plurality of field-level components.

At 312, the plurality of field-level components of the compliance event logs are time stamped using a trusted time stamp. For example, the blockchain facilitator may transmit the blockchain facilitator compliance event log or a hash thereof to the trusted time authority, which may generate a trusted time stamp token for the received blockchain facilitator compliance event log and transmit the trusted time stamp token back to the blockchain facilitator computing system. In some embodiments, the blockchain facilitator compliance event logs, or field-level components thereof, are time stamped as they are generated. However, in other embodiments, multiple blockchain facilitator compliance event logs or field-level components thereof are collected and time stamped as a group.

At 314, the time stamped field-level components are selectively encrypted based on permissions associated with each of the plurality of subscribers associated with the respective components.

At 316, the selectively encrypted, field-level components of the blockchain facilitator compliance event logs are stored on the event blockchain 115. In some arrangements, the blockchain facilitator may store all compliance event data over a first time period before selectively encrypting and publishing the plurality of the compliance event data to the event blockchain 115. In other arrangements, the blockchain facilitator publishes the compliance event data upon receipt of the time stamped token and after encrypting the information using the subscriber-specific algorithm. The blockchain facilitator policy in the policy blockchain 113 and the blockchain facilitator compliance event logs related to each subscriber are accessible by the respective subscribers to evaluate compliance of the blockchain facilitator to the service policy regarding the respective subscriber.

FIG. 4A is a schematic flow diagram illustrating a method 400 of managing the blockchain facilitator policy and event blockchains 113, 115 of FIGS. 1 and 2, according to an example embodiment. As shown, the blockchain facilitator 102 publishes policies and subsequent policy versions to the policy blockchain 113. Method 400 is described in greater detail below in FIG. 4B. The blockchain facilitator 102 also publishes compliance event logs to the event blockchain 115 according to the method 401. Method 401 is described in greater detail below in FIG. 4C. The event blockchain 115 and policy blockchain 113 are monitored by a subscriber for compliance and auditing purposes. For example, the blockchain facilitator may be an entity who operates the blockchain facilitator computing system 102 of FIGS. 1 and 2. The subscriber may be an entity that manages subscriber computing systems 106 of FIGS. 1 and 2.

Generally, the blockchain facilitator 102 adopts policies and practices that are published to the policy blockchain 113, and entities with the proper clearance may review and accept the policies and practices. The policy information may include non-restricted information, viewable by subscribers, auditors, regulators, potential new subscribers, and the like, without requiring a content encryption key. The practices information can be selectively encrypted and may outline the specific information related to the actions the blockchain facilitator has agreed to take in regards to the blockchain facilitator's policies for one or more subscribers. As shown in FIG. 4A the policy has four versions (v1.0, v1.1, v1.2, and v2.0) over the life of the policy blockchain 113. A subscriber may review the policy blockchain 113 to examine the current policies and practices, as well as the change over time in the policies and practices. For example, from Policy v1.0 to Policy V2.0 Item A and Item B have new versions, Item C remains unchanged, and Item D has been added. The Items refer to practices and policies, for example, that the blockchain facilitator will monitor for breaches on a daily basis. Once the current version of the policies and practices are published to the policy blockchain 113, entities with the proper clearance may review and accept the policies and practices.

The blockchain facilitator 102 also generates compliance events that are published to the event blockchain 115. The compliance events may include, for example, the execution of procedures, blockchain facilitator actions and other interactions of the blockchain facilitator arising from the duties and practices performed for the subscribers. Each of the blockchain facilitator compliance event logs may include a plurality of field-level components. Each event log is selectively encrypted and accessible for monitoring by entities that possess the proper credentials. As shown in FIG. 4A, there have been five event blocks (Events T0, T1, T2, T3, and T4) published to the event blockchain 115. Each event may be related to a specific subscriber and encrypted such that only the subscriber and authorized entities may decrypt and view the information. For example, Event 1 may correspond to blockchain facilitator activities related to a subscriber One. Event 2 may relate to a global compliance event executed on behalf of all subscribers and, while encrypted, accessible to all subscribers.

FIG. 4B is a flow diagram of a method 400 of managing the policy blockchain 113 of FIGS. 1 and 2 for multiple subscribers, according to an example embodiment. The method 400 is shown in connection with a blockchain facilitator 102, a regulator 408, a Client One 404, a Client Two 406, a Client Three 410, and plurality of policy blockchain entries on the policy blockchain 113. For example, the blockchain facilitator may be an entity who operates the blockchain facilitator computing system 102 of FIGS. 1 and 2. The regulator may be an entity that manages the auditor computing system 108 of FIGS. 1 and 2. Client One, Client Two, and Client Three may be entities that manage subscriber computing systems 106 of FIGS. 1 and 2. However, the method 400 may be similarly performed by other systems and devices.

At 414, the blockchain facilitator publishes a first policy (“Policy v1.0”) to the policy blockchain 113 at a first time (e.g., in January of 2008). The policy blockchain 113 can be fully encrypted, selectively encrypted or unencrypted. As shown in FIG. 4B, Policy v1.0 is unencrypted. First, the regulator 408 views the policy blockchain 113 and either approves or rejects the policy set forth by the blockchain facilitator. If approved, the blockchain facilitator 102 is able to provide services to the financial sector. Client One 404 is able to view the Policy v1.0 to make a determination if the policies outlined in Policy v1.0 are in accordance with the service Client One requires. Client One 404 agrees to become a subscriber and events related to Client One 404 will be published to the event blockchain 115. Client Two 406 reviews the policies of Policy v1.0 and determines that the policies are in accordance with the needs of Client Two 406 and decides to subscribe to the blockchain facilitator. Client Two 406 agrees to become a subscriber and events related to Client Two 406 will be published to the event blockchain 115. Client Three 410 does not review Policy v1.0.

At 416, the blockchain facilitator publishes a second policy (“Policy v1.1”) to the policy blockchain 113 at a second time (e.g., in January of 2010). There is no difference between the first policy and second policy, it is part of the regular updating of the policy by the blockchain facilitator. The regulator 408 views the Policy v1.1 in relation to Policy v1.0 and either approves or rejects the changes to the policy of the blockchain facilitator. Since there is no change in the policy between Policy v1.1 and Policy v1.0, the regulator approves the policy. Client One 404 is able to view the Policy v1.1 to make a determination if the policies outlined in Policy v1.1 are in accordance with the service Client One 404 requires. Client One 404 decides to continue to be a subscriber and events related to Client One 404 will continue to be published to the event blockchain 115. Client Two 406 is able to view the Policy v1.1 to make a determination if the policies outlined in Policy v1.1 are in accordance with the services Client Two 406 requires. Client Two 406 decides to cease being a subscriber and events related to Client Two 406 will cease to be published to the event blockchain 115. Client Three 410 does not review Policy v1.1.

At 418, the blockchain facilitator publishes a third policy (“Policy v2.0”) to the policy blockchain 113 at a third time (e.g., in November of 2011). The third policy is a change in policy from the previous two policies. The regulator 408 views the Policy v2.0 in relation to Policy v1.1 and Policy v1.0 and either approves or rejects the changes to the policy of the blockchain facilitator. If approved, the blockchain facilitator is able to continue provide services to the financial sector in accordance with Policy v2.0. Client One 404 is able to view Policy v2.0 to make a determination if the policies outlined in Policy v2.0 are no longer in accordance with the service Client One 404 requires. For example, Policy v2.0 allows the blockchain facilitator 302 to data mine the subscribers, a practice Client One 404 does not like. Client One 404 decides to cease being a subscriber and events related to Client One 404 will cease to be published to the event blockchain 115. Client Three 410 reviews Policy v2.0 and decides that the policy is almost what is in accordance with the needs of Client Three 410. Client Three 410 decides to engage in a SLA 420 between the blockchain facilitator 102 that adds additional policy requirements in regard to the services provided by the blockchain facilitator 102 to Client Three 410. In some arrangements, the SLA 420 is stored in a secure database and not published to the policy blockchain 113. In other arrangements, the SLA 420 is stored on the policy blockchain 113 but it is encrypted and only accessible to a permissioned entity.

FIG. 4C is a flow diagram of a method 401 of managing the event blockchain 115 of FIGS. 1 and 2 for multiple subscribers, according to an example embodiment. The method 401 illustrates the generation of the event blockchain 115 for multiple subscribers, as well as the interactions between the blockchain facilitator 102, subscribers 404, 406, and a regulating entity 408. The event blockchain 115 includes a list of the compliance events performed by the blockchain facilitator 102 throughout the lifespan of the blockchain facilitator services (or, alternatively, documenting the first event when the event blockchain 115 was created). The events include, for example, the execution of procedures, blockchain facilitator actions and other interactions of the blockchain facilitator 102 arising from the duties and practices performed for the subscribers. The event blockchain 115 is encrypted, requiring authorization to retrieve a decryption key to view one or more event blocks on the event blockchain 115.

The event blockchain 115 may implement a variety of publishing mechanisms depending on the desired schema of the blockchain facilitator 102. In some arrangements, compliance event data can be time stamped, encrypted, and published to the event blockchain 115 as the compliance event occurs. In other arrangements, the compliance event data are time stamped upon receipt, cataloged, and stored over a period of time, eventually the plurality of compliance events of the period of time are encrypted and published to the event blockchain 115. This schema is shown in FIG. 4C, wherein T1 represents the compliance event data over a 7 day period.

The method 401 may be performed in connection with the method 300 of FIG. 3 or method 400 of FIG. 4B. However, the method 401 may similarly be performed in connection with other types of transactions. The method 401 is shown in connection with the blockchain facilitator 102, the Client One 404, the Client Two 406, the regulator 408, and a plurality of compliance event entries in the event blockchain 115 over a period of time. The blockchain facilitator 102 may be an entity who operates the blockchain facilitator computing system 102 of FIGS. 1 and 2. The regulator may be an entity that manages the auditor computing system 108 of FIGS. 1 and 2. Client One 404 and Client Two 406 may be an entity that manages the subscriber computing systems 106 of FIGS. 1 and 2. However, the method 401 may be similarly performed by other systems and devices.

At T1, the blockchain facilitator 102 has only one subscriber, Client One 404. The compliance event entries for the event blockchain 115 at T1 only includes compliance data for Client One (“C1”). C1 can comprise all of the compliance related actions taken by the blockchain facilitator 102 over the time period of one week. For example, one of the event blockchain 115 entries could contain an event instance of a breach occurrence with the trusted time stamp and another event instance could signify the blockchain facilitator 102 notifying Client One 404 of the breach.

At T2, the blockchain facilitator 102 has added another subscriber, Client Two 406. The second blockchain entry, T2, contains C1 and the compliance data for Client Two (“C2”). C2 can comprise all of the compliance related actions taken by the blockchain facilitator 102 over the time period of one week for Client Two 406. At the end of the week, the time stamped compliance data of C1 is encrypted according to the encryption algorithm used for Client One 404. The time stamped compliance data of C2 is encrypted according to the encryption algorithm used for Client Two 406, and the encrypted data for C1 and C2 are published to the event blockchain 115 for T2. In some arrangements, the entire block, T2, may be time stamped when it is published to the event blockchain 115. At any time, Client One 404 or Client Two 406 could use a content encryption key to view the compliance data information related to them on the event blockchain 115. In some arrangements, the subscribers may have a multi-use content encryption key that they receive when initially subscribing that allows them to view their client-specific compliance data on the blockchain. In other arrangements, the subscribers may have to request access to their information and/or engage in a key establishment method to get the content encryption key, similar to method 500 of FIG. 5.

At T3, a regulator 408 requests access to the event blockchain 115. The regulator 408 may request to view the entire event blockchain 115 for Client One 404 and Client Two 406, the regulator 408 may request access to view the event blockchain 115 entries for one client, or the regulator 408 can request access to view the event blockchain 115 for a time range, for example T3. To gain access to the content encryption key(s) to view the information, the regulator 408 and the blockchain facilitator 102 can engage in a key establishment and key exchange method similar to method 500 shown in FIG. 5. Alternatively, the regulator 408 could already have a content encryption key either through a prior arrangement with the blockchain facilitator 102 or, if the regulator 408 is an auditing agency for a subscriber, from Client One 404 or Client Two 406.

At T4, Client Two 406 cancels its subscription to (or decommissions from) the blockchain facilitator 102. The event blockchain 115 still contains all of the prior entries, but no longer collects data, or uses the content encryption key associated to Client Two 406. Client Two 406 can still access the client specific information C2 at T2 and T3 using the previously assigned content encryption key.

FIG. 5 is a flow diagram of a method 500 of a key exchange between a blockchain facilitator and a requesting party, according to an example embodiment. The blockchain facilitator may be an entity who operates the blockchain facilitator computing system 102 of FIGS. 1 and 2. The requestor may be an entity that manages the subscriber computing system 106 of FIGS. 1 and 2 or the auditor computing system 108 of FIGS. 1 and 2. However, the method 500 may be similarly performed by other systems and devices. The content encryption key is being encrypted to protect the information from use by man-in-the-middle attacks or unauthorized access. By negotiating a KEK to encrypt content the encryption key, the blockchain facilitator and requesting entity can ensure that the content encryption key is received by only the authorized requesting party.

At 502, a requestor (e.g., a subscriber, a regulatory entity, an auditing agency, and the like) transmits a request to access a portion of a permissioned blockchain that contains a plurality of event information logs. Each event information log can have a plurality of individual elements (e.g., field-level components). Each event log can include one or more events over a period of time for a single subscriber to the blockchain facilitator's service. The event information logs are subscriber-specific and encrypted using one or more encryption algorithms. The encryption algorithm could be an algorithm that complies with the X9.119 financial services security standard, for example, a tokenization encryption method. To an unauthorized party, the blockchain looks like a random string of information, unusable without the right content encryption key(s). In some embodiments, the encryption algorithm can be unique for each individual element within the event log element on the permissioned blockchain. In some arrangements, the encryption algorithm can be unique to a group of elements within the plurality of individual element of the event log on the permissioned blockchain. In other arrangements, the encryption algorithm can be similar for the plurality of individual elements of the entire event log on the permissioned blockchain. In some arrangements, the encrypted blockchain could have an embedded URL link through which a viewer of the blockchain could begin the request process.

The construction of the permissioned event blockchain 115 allows for selective access to information on the blockchain. For example, the encryption algorithms used would allow the blockchain facilitator to grant access to view all event information related to one of the plurality of subscribers to the blockchain facilitator by issuing a content encryption key to a requesting entity. The rest of the information on the blockchain, that the requesting entity is not authorized to view, remains encrypted. Alternatively, the blockchain facilitator can issue a content encryption key that allows a requesting entity to view all of the subscriber information over a period of time. For example, the blockchain facilitator may receive a request from a legal entity to view all of the information on a particular day that an event, such as a breach, occurred. The blockchain facilitator could issue a key that allows the legal entity to view only the event information for that single day. Additionally, the blockchain facilitator could issue a content encryption key that allows the requesting entity access to view the entire event blockchain 115. For example, a regulator may be issued an all access content encryption key to monitor the blockchain facilitator's services and actions in accordance with regulations and policies.

At 504, the blockchain facilitator receives the access request from the requestor. In some arrangements, the request is transmitted from the subscriber computing system 106 and is received by the blockchain facilitator. In some arrangements, the request is transmitted from the auditor computing system 108 and is received by blockchain facilitator. The request can include a request to access a specific event on the event blockchain 115, a specific client's information on the blockchain, multiple clients' information on the blockchain, the entire blockchain, or any combination thereof.

After receiving the request, at 506, the blockchain facilitator authenticates the requestor and determines what information and/or event logs need to be decrypted to be viewed by the requesting party. The blockchain facilitator may determine to grant full access requested by the requesting entity. The blockchain facilitator could also determine to grant partial access or no access to the requesting entity depending on the requestor's identity. In some arrangements, the requesting entity may have an access account with the blockchain facilitator, allowing the requesting entity to “login” using a secure server to submit a request. For example, the requesting entity may be an auditing service that regularly interacts with the blockchain facilitator and has login information to authenticate itself or the requesting entity may be a client who is a subscriber to the blockchain facilitator services. In some arrangements, the requesting entity may have to provide additional information in order to authenticate.

At 508, the blockchain facilitator determines what blockchain encrypting key is needed for decrypting the information for the requesting entity and retrieves the content encryption key. Depending on the determined level of access at 506, the provided content encryption key may vary. In some arrangements, multiple content encryption keys may be required to decrypt event log information on the blockchain that is encrypted by a plurality of content encryption algorithms. In some arrangements, a single content encryption key is used to encrypt all the event information for a single client. In other words, a single key is used to encrypt Client A's information at the same time, every time. In other arrangements, a separate content encryption key is used for every client and for every event log on the blockchain.

Once the approved information is identified and the corresponding content encryption keys are identified, at 510, the blockchain facilitator transmits a key negotiation method or protocol. The key negotiation method may be responsive to the blockchain encryption algorithms used. The key negotiation method is the method that will generate a KEK and use the KEK to encrypt the content encryption key. This is done to ensure the privacy and security of the content encryption key as it is transmitted between the blockchain facilitator and the requesting entity. In some embodiments, an asymmetric key management method is initiated by the blockchain facilitator. In other embodiments, a symmetric key management method is initiated by the blockchain facilitator. In some arrangements, the blockchain may utilize key management techniques in support of asymmetric encryption, such as NamedKeyEncryptedData, SigncryptedData, EnvelopedData, or similar cryptographic message types.

In some embodiments, steps 510, 512, 514, and 516 are performed out-of-channel on a dedicated secure server, where a multi-use KEK is established for future use in access requests. For example, when a subscriber first enrolls with the blockchain facilitator, they are issued an encryption key for decrypting all event blockchain 115 information related to the new subscriber. In other embodiments, steps 510, 512, 514, and 516 involve public-key cryptosystems for secure data transmission, for example the RSA certificate. In some arrangements, steps 510, 512, 514, and 516 utilize a public key ecosystem and a shared secret similar to the Diffie-Hellman key exchange algorithm.

At 512, the requesting entity receives the blockchain facilitator provided key negotiation method request. At 514, the requesting entity can agree to the key negotiation method request. In some arrangements, this may require the requesting entity to generate a requesting entity key and swap the algorithm and key-generated information with the blockchain facilitator in order to determine a mutual KEK to use to encrypt the content encryption key.

At 516, the blockchain facilitator receives the requestor's key agreement. In some arrangements, a new KEK is generated for each request. In other arrangements, the KEK is generated and used to handle requests for a period of time (e.g., over the period of a month). The blockchain facilitator uses the agreed upon key encryption method to generate the KEK and uses the KEK to encrypt the content encryption key. At 518, the blockchain facilitator transmits the encrypted content encryption key to the requesting entity.

At 520, the requestor receives the encrypted content encryption key. At 522, the requestor uses the agreed upon key negotiation method to decrypt the encrypted content encryption key, leaving the requestor with the content encryption key. At 524, the requestor uses the content encryption key to decrypt the information on the blockchain to which the blockchain facilitator approved access to for the specific requestor and given the submitted request.

FIG. 6 is a flow diagram of a method of exchanging and managing digital signatures, according to an example embodiment. The signature method used provides a trust anchor for a data log message published to the compliance blockchain system 112. Generally, the blockchain facilitator signs the data log message using a private key in a private-public key pair, the signing method binds the signature to the message to provide authentication and data integrity. The reviewing entity (e.g., subscriber, auditor, regulatory agency, etc.) “walks the chain” to the trust anchor. Walking the chain includes: checking the signature and identity of each certificate; examining the trust anchor authority back to the root; checking the key usage in each certificate; checking the validity of any dates in each certificate; and checking the status (e.g. through Certificate Revocation Lists, Online Certificate Status Protocol, etc.). In some embodiments, the digital signature method is used in parallel with the SignCryptedData key management technique.

FIG. 7 is a flow diagram of a method of obtaining a trusted time stamp token according to an example embodiment. Generally, the trusted time stamp (e.g., recognized by regulators, auditors, members of the financial sector, etc. as a trustworthy time stamp) token provides strong non-repudiation, authentication, and integrity for the data logs published in the compliance blockchain system 112. As shown in FIG. 7, the TSA computing system 104, a plurality of subscriber-specific information (“S1” and “S2”) generated by the blockchain facilitator computing system 102, the auditor computing system 108, and a portion of the event blockchain 115. The TSA computing system 104 may be an entity that operates the TSA computing system 104 of FIG. 2. The auditor computing system 108 may be an entity that operates the auditor computing system 108 of FIG. 2. The subscriber-specific information is generated by an entity that may operate the blockchain facilitator computing system 102 of FIG. 2.

The blockchain facilitator computing system 102 generates information related to S1 as Statement 1, signs the statement, generates a hash of the signed Statement 1, and transmits the information to the TSA computing system 104. The TSA computing system 104 is managed by any trusted time authority that can provide a trusted time token for a piece of information or data entry. The trusted time authority can be one that complies with the X9.95 standard, or those defined in similar standards by ISO/IEC and satisfies the legal and regulatory requirements. As shown in FIG. 7, the TSA computing system 104 is in communication with a plurality of time source entities, the International Time Authority, the National Measurement Institute, and a Master Clock. The TSA computing system 104 may use the time source entities to generate multiple time stamp tokens, each corresponding to a time source entity, or the TSA computing system 104 may determine a time consensus for which to generate a single time stamp token. The TSA computing system 104 generates a first time stamp token (“TST 1”) and returns it to the blockchain facilitator 102 to associate the TST 1 with Statement 1. The trusted time stamp token allows for a verifying entity to compare the hash of the information data entry to the information data entry to verify that they correspond to the same information and, because the time stamping authority is trusted, that the information data entry was generated at the time indicated on the time stamp. The information is published to the event blockchain 115. In some arrangements, the time stamp token is bound to the data log through a digital signature method and the entirety of the message is encrypted. In other arrangements, the data log is encrypted and subsequently bound to the time stamp token through a digital signature method.

The blockchain facilitator computing system 102 generates information related to S2 as Statement 2, the blockchain facilitator does not digitally sign the statement (this may be in accordance with an S2-specific practice), and transmits the information to the TSA computing system 104. The TSA computing system 104 generates a second time stamp token (“TST 2”) and transmits it to the blockchain facilitator computing system 102. The blockchain facilitator computing system 102 associates the TST 2 with Statement 2 and publishes it to the event blockchain 115. As shown in FIG. 7, the regulating entity has permission and credentials to publish to the event blockchain 115. The auditor computing system 108 examines the event blockchain 115 entries of Statement 1 and Statement 2 for compliance purposes and generates a compliance report as Block N. The auditor computing system 108 signs Block N, generates a hash, and transmits the hash to the TSA computing system 104. The TSA generates a third time stamp token (“TST 3”) and transmits the information to the auditor computing system 108. The auditor computing system 108 binds the TST 3 to Block N and publishes the message to the event blockchain 115. In some arrangements, the TSA computing system 104 may time stamp each individual information data entry as it is generated by the blockchain facilitator's actions. In some embodiments, the blockchain facilitator computing system 102 may collect a plurality of information data entries before getting the plurality time stamped.

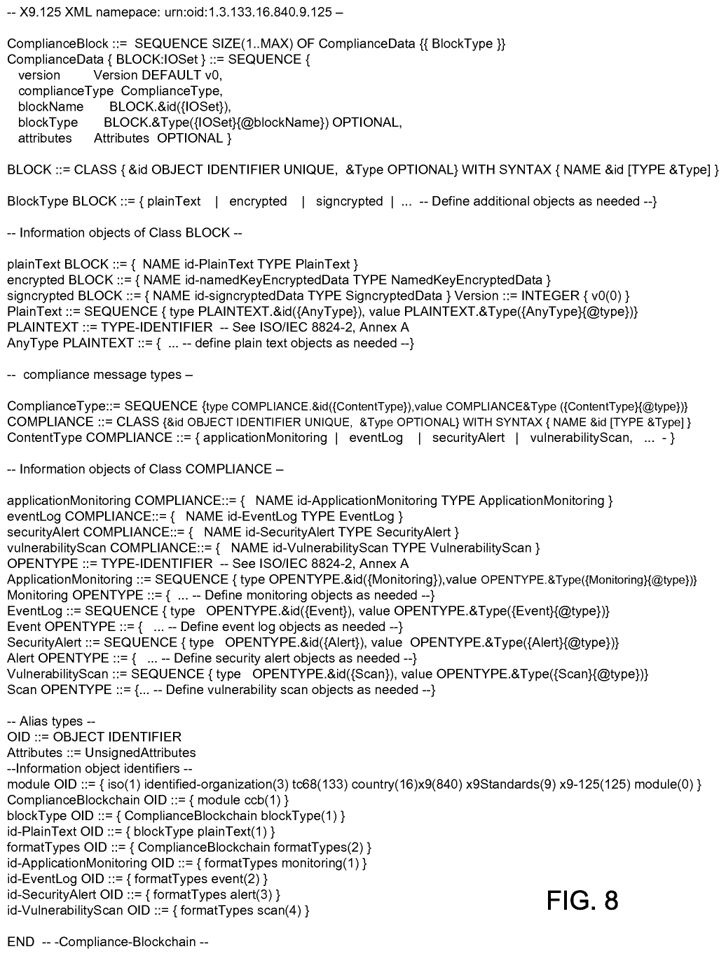

FIG. 8 is a compliance blockchain schema, according to an example embodiment. The schema is just one of a variety of implementations to accomplish the features and methods described herein. The schema in FIG. 8 provides for a plurality information objects of class Block, compliance message types, a plurality of information objects of Class Compliance, and a plurality of alias types. The schema allows for additional user defined parameters.

The compliance blockchain schema can take a variety of forms. Generally, the schema provides for the blockchain facilitator to generate a policy and practices versions in blocks on the policy blockchain. The schema allows for the blockchain facilitator to create an OID any of its forms or formats (e.g., as defined in the ISO/IEC 8824 and ISO/IEC 9834 standards). The schema also allows for the generation of a UUID, or one of its GUID variations (e.g., as defined in the ISO/IEC 9834-8 standard). In some arrangements, the schema allows for the creation of a URI (e.g., as defined in RFC 2396), a cryptographic hash, a digital signature, a MAC, a keyed HMAC, or tokenized representation of the policies, that can be used in an instance of communication or information exchange to uniquely identify a specific version of a block on the policy blockchain 113. In some embodiments, the schema allows for the generation of a policy type identifier, where the policy type identifier is an association between each blockchain facilitator policy and practices version in the policy blockchain 113 and the corresponding event blockchain 115. The schema allows for the identification and creation of OIDs related to compliance to the related policies and practices including, for example, historical operations, monitoring, and incident and response information.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server). To that end, a “circuit” as described herein may include components that are distributed across one or more locations.

An exemplary system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

1. A computer-implemented method performed by a blockchain facilitator, the method comprising:
defining, by a computing system, a service policy;
storing, by the computing system, the service policy in a policy blockchain, the policy blockchain including a plurality of blocks, a first block of the plurality of blocks including a first version of the service policy and a second block of the plurality of blocks including an update to the first version of the service policy;
capturing, by the computing system, a plurality of first compliance event logs over a first time period for a plurality of subscribers of the blockchain facilitator, each of the plurality of first compliance event logs including a first plurality of field-level components;
time stamping, by the computing system, each of the first plurality of field-level components within each of the plurality of first compliance event logs via a plurality of trusted time stamp tokens received from a trusted timing authority;
encrypting, by the computing system, a first field-level component and a second field-level component of the plurality of first compliance event logs based on a plurality of permissions associated with each of the plurality of subscribers, the plurality of permissions prescribing the decryption ability granted to each of the plurality of subscribers,
wherein encrypting the first field-level component comprises encrypting the first field-level component with a first content encryption key associated with a first permission of the plurality of permissions granted to a first subscriber of the plurality of subscribers and encrypting the second field-level component comprises encrypting the second field-level component with a second content encryption key associated with a second permission of the plurality of permissions granted to a second subscriber of the plurality of subscribers, and wherein the first content encryption key is a symmetric key;
negotiating, by the computing system, a first key encryption key with the first subscriber, the first key encryption key being an asymmetric key;
encrypting, by the computing system, the first content encryption key using the first key encryption key to generate an encrypted content encryption key;
transmitting, by the computing system, the encrypted content encryption key to the first subscriber, wherein the first key encryption key may be used by the first subscriber to decrypt the encrypted first content encryption key, and wherein the decrypted first content encryption key may be used by the first subscriber to decrypt the first field-level component;
storing, by the computing system in an event blockchain at an end of the first time period, the encrypted first field-level component and the encrypted second field-level component,
wherein the policy blockchain and the event blockchain are accessible by the first subscriber and the second subscriber, the first field-level component accessible to the first subscriber to evaluate compliance of the blockchain facilitator to the service policy regarding the first subscriber;
notifying, responsive to detecting a violation of the service policy, the plurality of subscribers based on a plurality of timings associated with each of the plurality of subscribers, the plurality of timings prescribing a timeframe within which the plurality of subscribers are to be notified;
defining, by the computing system, a second service policy;
storing, by the computing system, a portion of the second service policy in the policy blockchain, the portion of the second service policy comprising terms of the second service policy that differ from terms of the first service policy;
capturing, by the computing system, a plurality of second compliance event logs over a second time period for the plurality of subscribers of the blockchain facilitator, wherein the second compliance event logs are only associated with the second service policy, and wherein each of the plurality of second compliance event logs include a second plurality of field-level components;
time stamping, by the computing system, each of the second plurality of field-level components within each of the plurality of second compliance event logs via the plurality of trusted time stamp tokens received from a trusted timing authority;
selectively encrypting, by the computing system, the second plurality of field-level components of the plurality of second compliance event logs based on permissions associated with each of the plurality of subscribers; and
storing, by the computing system in a second event blockchain, the encrypted second plurality of field-level components,
wherein the second event blockchain includes compliance events associated with the second service policy, and wherein the policy blockchain and the second plurality of field-level components of the plurality of second compliance event logs related to the first subscriber of the plurality of subscribers are accessible by the first subscriber to evaluate compliance of the blockchain facilitator to the second service policy regarding the first subscriber.

2. (canceled)

3. The method of claim 1,
wherein a first of the plurality of first compliance event logs relating to the first subscriber comprises the first field-level component,
wherein a second of the plurality of first compliance event logs relating to the second subscriber comprises the second field-level component, and
wherein the second content encryption key is different than the first content encryption key.

4. The method of claim 1, wherein the encrypted content encryption key is a first encrypted content encryption key, and wherein encrypting the first field-level component further includes:
negotiating, by the computing system, a second key encryption key with each of the first subscriber and a third-party entity;
encrypting, by the computing system, the first content encryption key using the second key encryption key to generate a second encrypted content encryption key; and
transmitting, by the computing system, the second encrypted content encryption key to each of the first subscriber and the third-party entity,
wherein the second key encryption key may be used by each of the first subscriber and the third-party entity to decrypt the second encrypted content encryption key, and
wherein the decrypted first content encryption key may be used by each of the first subscriber and the third-party entity to decrypt the first field-level component.

5. The method of claim 4, wherein negotiating the second key encryption key includes:
receiving, by the computing system, an event blockchain access request from the third-party entity;
authenticating, by the computing system, the third-party entity to ensure that the third-party entity has permission to view the plurality of first compliance event logs associated with the first subscriber; and
generating, by the computing system, the second key encryption key upon authenticating the third-party entity.

6. The method of claim 1, wherein each of the plurality of first compliance event logs include a policy identifier relating to a version of the service policy in effect at the time that the respective compliance event logs were captured.

7. The method of claim 1, further comprising:
defining, by the computing system, a policy practice associated with the first subscriber;
encrypting, by the computing system, the policy practice using an encryption key associated with the first subscriber; and
storing, by the computing system, encrypted policy practice in the policy blockchain, wherein the service policy is stored in the blockchain as cleartext.

8. The method of claim 1, wherein time stamping further comprises:
generating, by the computing system, a hash of each of the first plurality of field-level components within each of the plurality of first compliance event logs;
transmitting, by the computing system, the hash to the trusted timing authority; and
receiving, by the computing system, the trusted time stamp token from the trusted timing authority in response to transmitting the hash.

9. The method of claim 1,
wherein encrypting the first field-level component includes tokenizing, by the computing system, the first field-level component by replacing the first field-level component with a token to generate a tokenized field-level component,
wherein the tokenized field-level component may be detokenized by the first subscriber to recover plaintext of the first field-level component.

10. The method of claim 1, wherein encrypting the first field-level component includes:
signcrypting, by the computing system, the first field-level component, wherein signcrypting includes simultaneously digitally signing and encrypting the first field-level component.

11. The method of claim 1, further comprising:
receiving, by the computing system, a regulator check event log, the regulator check event log being a compliance event log generated by a regulatory entity, the compliance event log being a review of the first plurality of field-level components in the event blockchain;
selectively encrypting, by the computing system, the regulator check event log based on permissions associated with each of the plurality of subscribers and the regulatory entity; and
storing, by the computing system in the event blockchain, the encrypted regulator check event log.

12. (canceled)

13. A system, comprising:
a blockchain system comprising a policy blockchain and an event blockchain;
a server system in operative communication with the blockchain system, the server system comprising a processor and instructions stored in non-transitory machine-readable media, the instructions configured to cause the server system to:
define a service policy;
store the service policy in the policy blockchain, the policy blockchain including a plurality of blocks, a first block of the plurality of blocks including a first version of the service policy and a second block of the plurality of blocks including an update to the first version of the service policy;
capture a plurality of first compliance event logs over a first time period for a plurality of subscribers of the blockchain facilitator, each of the plurality of first compliance event logs including a first plurality of field-level components;
time stamp each of the first plurality of field-level components within each of the plurality of first compliance event logs via a trusted time stamp token received from a trusted timing authority;
selectively encrypt the first plurality of field-level components of the plurality of first compliance event logs based on a plurality of permissions associated with each of the plurality of subscribers,
wherein encrypting first field-level components comprises encrypting the first field-level components with a first content encryption key associated with a first permission of the plurality of permissions granted to a first subscriber of the plurality of subscribers and encrypting second field-level components comprises encrypting the second field-level components with a second content encryption key associated with a second permission of the plurality of permissions granted to a second subscriber of the plurality of subscribers, and wherein the first content encryption key is a symmetric key;
negotiate a first key encryption key with the first subscriber, the first key encryption key being an asymmetric key;
encrypt the first content encryption key using the first key encryption key to generate an encrypted content encryption key;
transmit the encrypted content encryption key to the first subscriber, wherein the first key encryption key may be used by the first subscriber to decrypt the encrypted first content encryption key, and wherein the decrypted first content encryption key may be used by the first subscriber to decrypt the first field-level components;
store, at an end of the first time period, the encrypted field-level components in the event blockchain,
wherein the policy blockchain and the event blockchain are accessible by the first subscriber and the second subscriber, the first field-level components accessible to the first subscriber using the first content encryption key to evaluate compliance of the blockchain facilitator to the service policy regarding the first subscriber;
notify, responsive to detecting a violation of the service policy, the plurality of subscribers based on a plurality of timings associated with each of the plurality of subscribers, the plurality of timings prescribing a timeframe within which the plurality of subscribers are to be notified:
define a second service policy;
store a portion of the second service policy in the policy blockchain, the portion of the second service policy comprising terms of the second service policy that differ from terms of the first service policy;
capture a plurality of second compliance event logs over a second time period for the plurality of subscribers of the blockchain facilitator, wherein the second compliance event logs are only associated with the second service policy, and wherein each of the plurality of second compliance event logs include a second plurality of field-level components;
time stamp each of the second plurality of field-level components within each of the plurality of second compliance event logs via a trusted time stamp token received from a trusted timing authority;
selectively encrypt the second plurality of field-level components of the plurality of second compliance event logs based on permissions associated with each of the plurality of subscribers; and
store, in a second event blockchain, the encrypted second plurality of field-level components,
wherein the second event blockchain includes compliance events associated with the second service policy, and wherein the policy blockchain and the second plurality of field-level components of the plurality of second compliance event logs related to a first subscriber of the plurality of subscribers are accessible by the first subscriber to evaluate compliance of the blockchain facilitator to the second service policy regarding the first subscriber.

14. (canceled)

15. The system of claim 13,
wherein the first field-level components are associated with a first of the plurality of first compliance event logs relating to the first subscriber,
wherein the second field-level components are associated with a second of the first plurality of compliance event logs relating to a second subscriber, and
wherein the second content encryption key is different than the first content encryption key.

16. The system of claim 13, wherein selectively encrypting the field-level components further includes:
negotiating a second key encryption key with each of the first subscriber and a third-party entity;
encrypting the first content encryption key using the second key encryption key to generate a second encrypted content encryption key; and
transmitting the second encrypted content encryption key to each of the first subscriber and the third-party entity,
wherein the second key encryption key may be used by each of the first subscriber and the third-party entity to decrypt the second encrypted content encryption key, and
wherein the decrypted first content encryption key may be used by each of the first subscriber and the third-party entity to selectively decrypt the first field-level components.

17. The system of claim 16, wherein negotiating the second key encryption key includes:
receiving an event blockchain access request from the third-party entity;
authenticating the third-party entity to ensure that the third-party entity has permission to view the plurality of first compliance event logs associated with the first subscriber; and
generating the second key encryption key upon authenticating the third-party entity.

18. The system of claim 13, wherein each of the plurality of compliance event logs include a policy identifier relating to a version of the service policy in effect at the time that the respective compliance event logs were captured.

19. The system of claim 13, wherein the instructions are further configured to cause the server system to:
define a policy practice associated with the first subscriber;
encrypt the policy practice using an encryption key associated with the first subscriber; and
store the encrypted policy practice in the policy blockchain, wherein the service policy is stored in the blockchain as cleartext.

20. The system of claim 13, wherein time stamping further comprises:
generating a hash of each of the first plurality of field-level components within each of the plurality of compliance event logs;
transmitting the hash to the trusted timing authority; and
receiving the trusted time stamp token from the trusted timing authority in response to transmitting the hash.

21. The system of claim 13, wherein selectively encrypting the field-level components includes:
tokenizing the first field-level components by replacing the first field-level components of the plurality of first compliance event logs with a token;
wherein the token may be detokenized by the first subscriber to recover plaintext of the first field-level components.

22. The system of claim 13, wherein selectively encrypting the field-level components includes:
signcrypting the field-level components, wherein signcrypting includes simultaneously digitally signing and encrypting the field-level components.

23. The system of claim 13, wherein the instructions are further configured to cause the server system to:
receive a regulator check event log, the regulator check event log being a compliance event log generated by a regulatory entity, the compliance event log being a review of the first plurality of field-level components in the event blockchain;
selectively encrypt the regulator check event log based on permissions associated with each of the plurality of subscribers and the regulatory entity; and
store the encrypted regulator check event log in the event blockchain.

24. (canceled)
